(19) United States
(12) Patent Application Publication
(10) Pub. No.: US 2026/0023471 A1
(43) Pub. Date: Jan. 22, 2026

(54) METHOD OF PROVIDING JOURNAL BASED ON PERSONAL KNOWLEDGE GRAPH AND USER DEVICE USING THE METHOD

(71) Applicant: SAMSUNG ELECTRONICS CO., LTD., Suwon-si (KR)

(72) Inventors: Junghwan LEE, Suwon-si (KR); Myunghee Han, Suwon-si (KR); Namyun Kim, Suwon-si (KR); Sungwon Kim, Suwon-si (KR); Junbeom Kim, Suwon-si (KR); Kyoungjin Moon, Suwon-si (KR); Seohyeon Park, Suwon-si (KR); Yeonho Lee, Suwon-si (KR); Jinhe Jung, Suwon-si (KR); Hyunkook Cho, Suwon-si (KR)

(73) Assignee: SAMSUNG ELECTRONICS CO., LTD., Suwon-si (KR)

(21) Appl. No.: 19/272,730

(22) Filed: Jul. 17, 2025

Related U.S. Application Data
(63) Continuation of application No. PCT/KR2025/010396, filed on Jul. 15, 2025.

(30) Foreign Application Priority Data
Jul. 18, 2024 (KR) 10-2024-0095282
Sep. 13, 2024 (KR) 10-2024-0126183
Jan. 6, 2025 (KR) 10-2025-0001834
Jan. 6, 2025 (KR) 10-2025-0001835

(51) Int. Cl. G06F 3/04845; G06F 3/04842; G06N 5/022; G06T 11/60

(52) U.S. Cl. CPC G06F 3/04845; G06F 3/04842; G06N 5/022; G06T 11/60

(57) ABSTRACT

A method of providing a personal knowledge graph-based journal includes generating a journal using a personal knowledge graph based on user data having a co-relationship, displaying a first image and a text of the journal in a first area of a display screen, the first image being generated based on first user data used to generate the journal, obtaining a user input for modifying the first image displayed in the first area, and changing the text of the journal based on the first image being modified.

### CROSS-REFERENCE TO RELATED APPLICATIONS

This application is a continuation of International Application No. PCT/KR2025/010396, filed on Jul. 15, 2025, in the Korean Intellectual Property Receiving Office, which is based on and claims priority to Korean Patent Application No, 10-2025-0001834, filed on Jan. 6, 2025, in the Korean Intellectual Property Office, Korean Patent Application No, 10-2025-0001835, filed on Jan. 6, 2025, in the Korean Intellectual Property Office, Korean Patent Application No, 10-2024-0126183, filed on Sep. 13, 2024, in the Korean Intellectual Property Office, and Korean Patent Application No, 10-2024-0095282, filed on Jul. 18, 2024, in the Korean Intellectual Property Office, the disclosures of which are incorporated by reference herein in their entireties.

### BACKGROUND

### 1. Field

The disclosure relates to a method of providing a journal based on a personal knowledge graph and a user device using the method.

### 2. Description of Related Art

Artificial intelligence (AI)-based technologies have been used in various fields across industries. Various AI models have been developed and used in various fields. Fields in which AI-based solutions are applied include manufacturing, robotics, transportation/logistics, medical treatment, education, pharmaceutical/bio industries, etc. are rapidly increasing. The introduction of such AI-based technologies has led to enhanced competitiveness for companies and countries.

In order to improve the performance of AI models, a knowledge base for training an AI model learning and inference by the AI model may be used. An example of a knowledge base is a knowledge graph that has a graph-type data structure

Recently, there has been an increasing interest in on-device AI technologies whereby a user device such as a smartphone autonomously collects and processes information, rather than technologies whereby information collected by a user device such as a smartphone is transmitted, analyzed, and transmitted back to the user device by a server.

Information in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

Additional aspects will be set forth in part in the description which follows and, in part, will be apparent from the description, or may be learned by practice of the presented embodiments.

According to an aspect of the disclosure, a method of providing a personal knowledge graph-based journal may include generating a journal using a personal knowledge graph based on user data having a co-relationship, displaying a first image and a text of the journal in a first area of a display screen, the first image being generated based on first user data used to generate the journal, obtaining a user input for modifying the first image displayed in the first area, and changing the text of the journal based on the first image being modified.

According to an aspect of the disclosure, a non-transitory computer-readable recoding medium may store instructions that, when executed by at least one processor, cause a device to execute a method of providing a personal knowledge graph-based journal.

According to an aspect of the disclosure, a user device may include memory storing instructions, at least one processor, and an input/output device configured to output a display screen, wherein the instructions, when executed by the at least one processor, cause the user device to generate a journal using a personal knowledge graph based on user data having a co-relationship, display a first image and a text of the journal in a first area of the display screen, the first image being generated based on first user data used to generate the journal, obtain a user input for modifying the first image displayed in the first area, and change the text of the journal based on the first image being modified.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram illustrating an artificial intelligence (AI) platform based on a personal knowledge graph, according to an embodiment of the disclosure;

FIG. 2A is a diagram illustrating an operation performed by a user device to construct a knowledge graph-based personalized database, according to an embodiment of the disclosure;

FIG. 2B is a diagram illustrating a usage of a personal knowledge graph generated in a user device according to an embodiment of the disclosure;

FIG. 3 is a diagram illustrating a personal knowledge graph generated in a user device according to an embodiment of the disclosure;

FIG. 4 is a flowchart illustrating a method of generating a personal knowledge graph, the method being performed by a user device according to an embodiment of the disclosure;

FIG. 5 is a diagram illustrating a first data group and a second data group which are clustered by a user device from user data related to a plurality of applications according to an embodiment of the disclosure;

FIG. 6 is a flowchart illustrating a process in which a user device extends and obtains a second data group, according to an embodiment of the disclosure;

FIG. 7 is a diagram illustrating a user device that extends a second data group, according to an embodiment of the disclosure;

FIG. 8 is a flowchart illustrating a process of obtaining, by a user device, a personal knowledge graph based on user data having a co-relationship, according to an embodiment of the disclosure;

FIG. 9 is a diagram illustrating an operation in which a user device provides a personal knowledge graph-based service, according to an embodiment of the disclosure;

FIG. 10 is a diagram illustrating a home screen and a journal provision screen of a journal application executed in a user device according to an embodiment of the disclosure;

FIG. 11 is a flowchart illustrating a method of providing a personal knowledge graph-based journal, according to an embodiment of the disclosure;

FIG. 12 is a diagram illustrating a process of editing, by a user device, a journal by changing a first image, according to an embodiment of the disclosure;

FIG. 13 is a diagram illustrating a process, performed by a user device, for modifying a first image and editing a journal, according to an embodiment of the disclosure;

FIG. 14 is a diagram illustrating a process, performed by a user device, for modifying a first image and editing a journal, according to an embodiment of the disclosure;

FIG. 15 is a diagram illustrating a process, performed by a user device, of editing a journal by modifying a text of a journal, according to an embodiment of the disclosure;

FIG. 16 is a diagram illustrating a process, performed by a user device, of editing a journal by modifying a text of a journal, according to an embodiment of the disclosure;

FIG. 17 is a flowchart illustrating a method of providing a personal knowledge graph-based journal, according to an embodiment of the disclosure;

FIG. 18 is a diagram illustrating a second image for journal editing displayed in a second area of a display screen of a user device, according to an embodiment of the disclosure;

FIG. 19 is a diagram illustrating a user device that edits a journal using a second image, according to an embodiment of the disclosure;

FIG. 20 is a diagram illustrating a user device that selects a tone to be applied to a journal and edits the journal, according to an embodiment of the disclosure;

FIG. 21 is a diagram illustrating a second image for journal editing displayed in a second area of a display screen of a user device, according to an embodiment of the disclosure;

FIG. 22 is a diagram illustrating a user device that edits a journal using a second image, according to an embodiment of the disclosure;

FIG. 23 is a block diagram illustrating a user device according to an embodiment of the disclosure; and

FIG. 24 is a block diagram illustrating a configuration and operations of a user device according to an embodiment of the disclosure.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

The terms used in the specification will be briefly defined, and the disclosure will be described in detail. Throughout the disclosure, the expression “at least one of a, b or c” may include only a, only b, only c, both a and b, both a and c, both b and c, all of a, b, and c, or variations thereof.

Although the terms used in the disclosure are selected from among common terms that are currently widely used in consideration of their functions in the disclosure, the terms may vary according the intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

As used herein, the singular forms “a,” “an,” and “the” may include the plural forms as well, unless the context clearly indicates otherwise. Unless otherwise defined, all terms including technical or scientific terms used herein may have the same meanings as commonly understood by one of ordinary skill in the art of the present disclosure. It will be understood that, although the terms “first”, “second”, etc. may be used in the specification so as to describe various components, these components should not be limited by these terms. These terms are only used to distinguish one component from another component. Operations of a method may be performed in an appropriate order unless explicitly described in terms of order. In addition, the use of all illustrative terms (e.g., etc.) is merely for describing technical ideas in detail, and the scope is not limited by these examples or illustrative terms unless limited by the claims.

Throughout the specification, when a part “includes” or “comprises” a component, unless there is a particular description contrary thereto, the part can further include other components, not excluding the other components. Also, the terms such as “unit,” “module,” or the like used in the specification indicate a unit, which processes at least one function or operation, and the unit may be implemented by hardware or software, or by a combination of hardware and software.

The functions related to artificial intelligence (AI) according to the disclosure are operated via a processor and memory. The processor may refer to one or more processors. In this regard, the one or more processors may include at least one of a general-purpose processor such as a central processing unit (CPU), an application processor (AP), a digital signal processor (DSP), or the like, a graphics-dedicated processor such as a graphics processing unit (GPU), a vision processing unit (VPU) or the like, or an AI-dedicated processor such as a neural processing unit (NPU). The one or more processors control input data to be processed according to a predefined operation rule or an AI model which is stored in the memory. Alternatively, when each of the one or more processors is an AI-dedicated processor, the AI-dedicated processor may be designed to have a hardware structure specialized for processing of a particular AI model.

The predefined operation rule or the AI model is made via training. Herein, when the predefined operation rule or the AI model is made via training, it may mean that a basic AI model is trained using multiple training data based on a learning algorithm so as to execute desired characteristics (or purpose), thus making the predefined operation rule or AI model. Such training may be performed by a device on which AI according to the disclosure is implemented or by a separate server and/or a system. Examples of the learning algorithm may include, but are not limited to, supervised learning, unsupervised learning, semi-supervised learning, or reinforcement learning.

The AI model may include a plurality of neural network layers. Each of the plurality of neural network layers has a plurality of weight values, and performs a neural network calculation via a calculation between a calculation result of a previous layer and the plurality of weight values. The plurality of weight values of the plurality of neural network layers may be optimized due to a training result of the AI model. For example, the plurality of weight values may be updated to reduce or minimize a loss value or a cost value obtained by the AI model during a training process. Examples of the AI neural network may include, but are not limited to, a deep neural network (DNN), a convolutional neural network (CNN), a recurrent neural network (RNN), a restricted Boltzmann machine (RBM), a deep belief network (DBN), a bidirectional recurrent deep neural network (BRDNN), and a DQN.

In the disclosure, a “knowledge graph” may refer to a scheme of managing and searching for knowledge information and refers to a graph-structured knowledge base based on a knowledge base that stores knowledge information and a graph that expresses knowledge information so as to be analyzed in a network structure. The knowledge graph is a graph model that implements knowledge accumulated in the knowledge base as a relationship between nodes and edges. The knowledge graph may be used to integrate data using graph data models, topologies, etc. In order to enable knowledge to be interconnected and integrated using a knowledge graph, a schema is implemented through ontology, and a structure and dictionary (terminology) that may be shared with each other are used.

Semantic information including commonsense and fact knowledge is organized as connections between nodes and edges, and various types of data may be converted into the form of a knowledge graph with reference to the semantic information. As a scheme of expressing a knowledge graph, a labeled property graph (LPG) in which a node and an edge each have properties, a resource description framework (RDF) that expresses a relationship in a triple structure of subject-predicate-object, etc. may be used, but the disclosure is not limited thereto. The knowledge graph may be generated by recognizing entities from various data, performing linking (entity linking) to appropriate entities in an existing knowledge base, and extracting a relationship between the entities.

The knowledge graph may be used to improve the performance of AI. The knowledge graph may be used in models, such as a graph neural network (GNN) or a graph convolution neural network (GCN), and may be used to provide a description of a result in explainable AI (XAI).

Hereinafter, an embodiment of the disclosure will be described in detail with reference to the accompanying drawings, so that one of ordinary skill in the art may easily carry out the disclosure. However, the disclosure may be implemented in various different forms and is not limited to the embodiment of the disclosure described herein.

Hereinafter, the disclosure will now be described in detail with reference to the accompanying drawings.

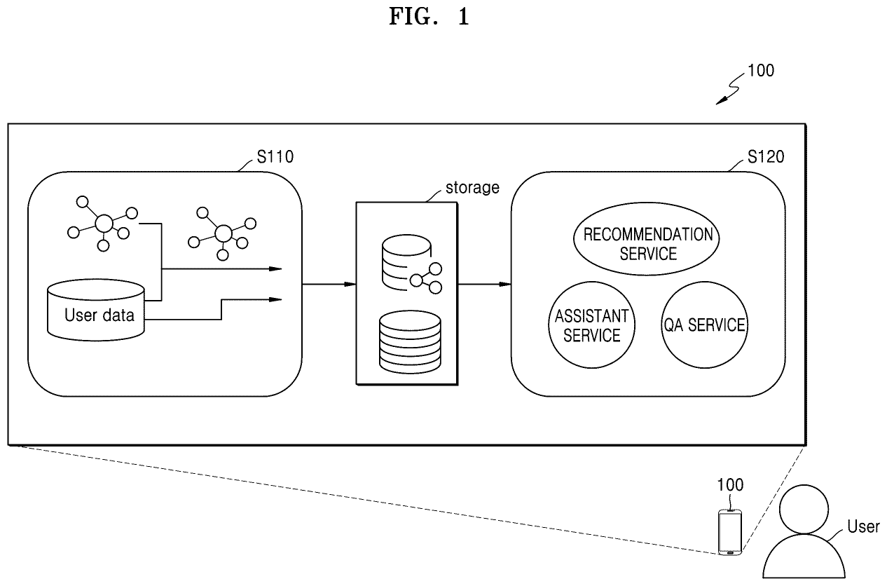

FIG. 1 is a diagram illustrating an AI platform based on a personal knowledge graph, according to an embodiment of the disclosure.

Referring to FIG. 1, the AI platform based on the personal knowledge graph is provided to a user by a process of constructing a knowledge graph-based personalized database (e.g., operation S110) and a process of providing a personalized AI service to a user via a knowledge graph-based service application (e.g., operation S120).

In the process of constructing the knowledge graph-based personalized database (e.g., operation S110), a user device 100 may generate a personal knowledge graph of a standardized form with reference to a general knowledge graph of a standardized form, such as commonsense and fact knowledge, using user data obtained by the user device 100. The user device 100 may convert various types of unstructured data into the form of a knowledge graph, may construct a knowledge graph-based personalized database, i.e., a personal knowledge graph, and may store the personal knowledge graph in a storage. The user device 100 may database user data obtained by the user device 100 and may manage the user data in a storage.

In the process of providing the personalized AI service to the user via the knowledge graph-based service application (e.g., operation S120), the user device 100 may provide various services using the personal knowledge graph and the databased user data stored in the storage. The user device 100 may provide a recommendation service, an assistant service, a question answering (QA) service, etc. using the personal knowledge graph.

For example, when an action is performed by the user, the user device 100 may use the recommendation service to recommend music that the user enjoys listening to while performing the action or may use the assistant service to provide knowledge information based on the personal knowledge graph as well as information about related past experiences or upcoming events (e.g., calendar schedules). The user device 100 may identify a user's behavioral pattern from the personalized database, and when the user exhibits a pattern that is different from a usual behavioral pattern, the user device 100 may use the recommendation service to provide a solution service related to the cause of the different pattern. The user device 100 may use the QA service to provide a customized answer to a user's question, based on the personalized database. The user device 100 may provide a journal service to manage and describe a user's daily work or special event, etc. using the personalized database.

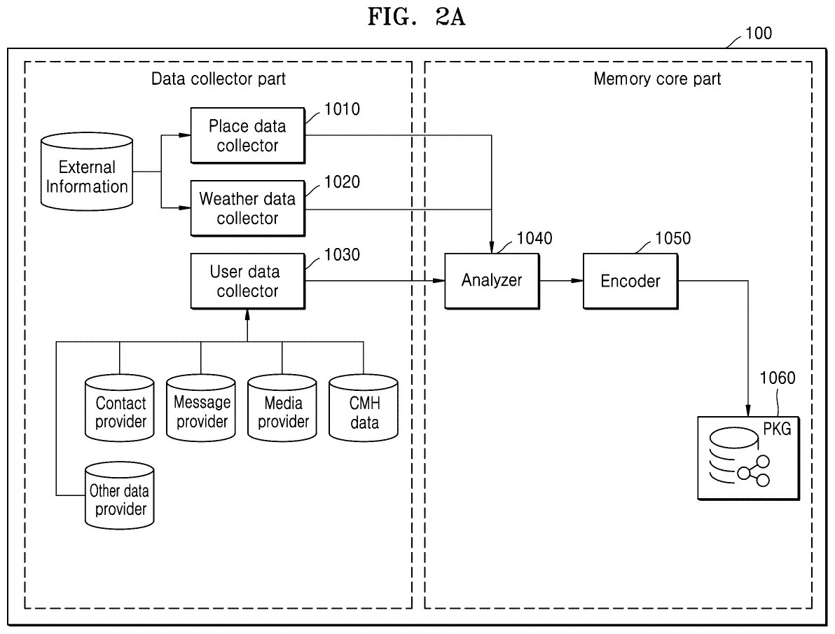

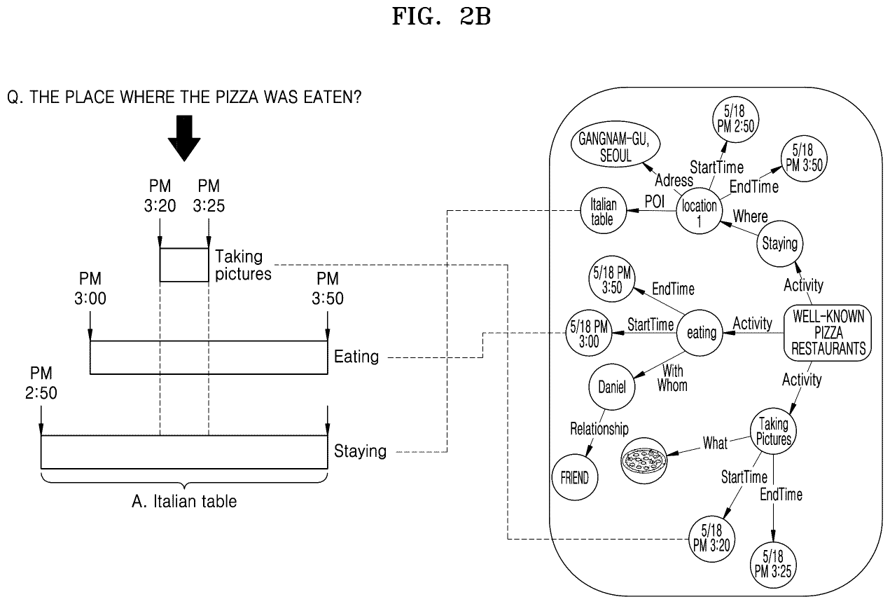

FIG. 2A is a diagram illustrating an operation performed by the user device 100 to construct a knowledge graph-based personalized database, according to an embodiment of the disclosure.

The user device 100 according to an embodiment of the disclosure may be an electronic device capable of processing data. For example, the user device 100 may be an electronic device such as a smartphone, smart glasses, a wearable device, a digital camera, a laptop computer, an augmented reality (AR) device, a virtual reality (VR) device, etc. Various types of neural network models may be mounted on the user device 100. For example, the user device 100 may have at least one of models, such as a CNN, a GCN, a GNN, a DNN, an RNN, or a BRDNN, mounted thereon, and may use a combination thereof.

The user device 100 according to an embodiment of the disclosure may convert various types of unstructured data into the form of a knowledge graph and construct a knowledge graph-based personalized database. The user device 100 may obtain various types of data and convert the data into triple format data. The user device 100 may map the converted data to ontology stored in a semantic memory and may reflect standardized data matching the ontology format to the personal knowledge graph (e.g., PKG in FIG. 2A). The ontology is a type of dictionary that defines terms conceptualizing data and a relationship between the terms. The ontology may be expanded by converting external knowledge into triple format data and adding the triple format data.

According to an embodiment of the disclosure, the data obtained by the user device 100 may be those stored in the user device 100 as user data related to an application executed in the user device 100 or metadata about event occurrence time, place, weather, etc. The data obtained by the user device 100 may include at least one of data input from the user via the user device 100, data detected by the user device 100, data received from the external source by the user device 100, or data processed by the user device 100.

The user device 100 may process unstructured data obtained by the user device 100 into structured data and may store the structured data in the personal knowledge graph. The user device 100 may previously prepare semantic information of a standardized form, as ontology. By referring to semantic information of various types of ontologies, the user device 100 may process unstructured data obtained by the user device 100 into structured data and may store the structured data in the personalized database. For example, the user device 100 may convert various types of unstructured data into the form of a knowledge graph and may store the knowledge graph in the personal knowledge graph.

FIG. 2A illustrates an example of a process performed by the user device 100 to collect the user data related to the application executed in the user device 100 and construct a personalized database in the form of a knowledge graph.

In a data collector portion of the user device 100, a user data collector 1030 may collect user data from a contact provider, a message provider, a media provider, content management hub (CMH) data, other data provider, etc. Each provider may store data at the level of raw data provided from at least one application. For example, the message provider may store user data in the form of raw data received from a text message application or a chat application. The user data collector 1030 is not limited to the example of FIG. 2A, and may collect user data from various types of applications including a third party application installed in the user device 100. A place data collector 1010 and a weather data collector 1020 may collect metadata about a place or weather from external information obtained by the user device 100. Referring to FIG. 2, the place data collector 1010, the weather data collector 1020, and the user data collector 1030 are separate, but embodiments are not limited thereto and these components may be integrated into one collector.

Each of the data collectors 1010, 1020, and 1030 collects log data or data at the level of raw data. For example, the user data collector 1030 may collect a picture file itself from a picture management application for managing pictures photographed by a camera. The user data collector 1030 may receive user data transmitted from each application according to a predefined protocol for each domain or each provider. When an event including addition, change, deletion, etc. of user data stored in each application occurs, the user data collector 1030 may receive, from each application, added user data, changed user data, or deleted user data.

In a memory core portion of the user device 100, an analyzer 1040 may generate user data in a new form using all or a part of data collected by each of the data collectors 1010, 1020, and 1030.

The analyzer 1040 may generate user data at the level of action information or activity information, from the data collected by each of the data collectors 1010, 1020, and 1030. The analyzer 1040 may infer and determine a user action of capturing a picture from the picture, a user action of eating food from a paid receipt of a restaurant, a user action of staying from global positioning system (GPS)-based position information of a place where a user is present, etc., and thus, may generate the user data at the level of action information or activity information. The action information may be user data corresponding to an operation (unit action) of the user, and the activity information may be user data configured with a plurality of pieces of sequential action information. The activity information may have attribute data in which a value of a start time and a value of an end time are different from each other, and the action information may have attribute data about a value of a time at which the operation of the user occurred. For example, with respect to watching movie, a time when the watching move started and a time when the watching movie ended are different, and thus, the watching movie may correspond to the activity information, but with respect to payment, a time when the payment occurred is momentary, the payment may correspond to the action information. However, the action information may be processed as one type of activity information in which a start time and an end time are equal.

The analyzer 1040 may generate user data at the level of a personal knowledge graph. The analyzer 1040 may obtain the action information or the activity information, based on the data collected by each of the data collectors 1010, 1020, and 1030, may connect entities as respective nodes related to the action information or the activity information, and may store attribute information of each node, thereby generating the personal knowledge graph. For example, the personal knowledge graph may be configured with a lower layer including user data at the level of raw data, a middle layer including user data at the level of action information or activity information, and an upper layer corresponding to a title or a topic of the personal knowledge graph and collectively including the action information or the activity information. A plurality of nodes corresponding to the activity information included in the middle layer may be connected to the uppermost layer of the personal knowledge graph. A plurality of nodes corresponding to the user data at the level of raw data included in the lower data may be connected as attribute data of each activity information to each node corresponding to the activity information. The nodes corresponding to the activity information of the personal knowledge graph may be connected to each other, and a node corresponding to another user data may be connected to a node corresponding to the user data. Nodes corresponding to similar user data included in one or more personal knowledge graphs may be clustered and managed as one group. For example, pictures including similar faces of a user may be managed as one group, and when attribute information about any one of the pictures is input, all the pictures in the same group may share the input attribute information. It may be processed in such a manner that, when any one picture in the same group is deleted, all pictures in the same group are deleted from one or more personal knowledge graphs in the same group. As another example, a personal knowledge graph may represent user data generated during a preset period by designating the preset period information as the rood node, with each node connected to the root node. The root node may be searched for using the preset period information. The root node may be connected to each personal knowledge graph where each sub-period information, constituting preset period information, is a sub-root node.

An encoder 1050 may convert user data into triple format data, the user data being generated or processed by the analyzer 1040, may map the converted user data to preset ontology, may infer standardized data matching the ontology format, and may construct a personal knowledge graph in storage 1060 or may reflect the inferred data to an existing personal knowledge graph. Various types of ontologies such as content ontology, user activity ontology, environment ontology, or relationship ontology may be previously prepared in the user device 100. The encoder 1050 may collectively use the various ontologies prepared in the user device 100. For example, the encoder 1050 may convert information of card payment occurred on January 1 and user data related to a picture photographed on January 1 to triple format data, may identify the converted user data as each of activity information of the payment and activity information of taking pictures occurred on January 1, and may generate or update a personal knowledge graph based on the activity information in a standardized form.

The storage 1060 may store personal knowledge graph. The user device 100 may manage personal knowledge graphs by constructing a knowledge graph-based personalized database in the storage 1060. The user device 100 may record and store data related to an event occurred by a user for each preset period, the data in a personal knowledge graph form. In order to record and manage events occurred in the user device 100, using various types of user data, the user device 100 may store and manage a personal knowledge graph including each node as an entity related to an event.

FIG. 2B is a diagram illustrating a usage of a personal knowledge graph generated in the user device 100 according to an embodiment of the disclosure.

Referring to FIG. 2B, the user device 100 according to an embodiment of the disclosure may collect user data obtained by the user device 100, and may generate a personal knowledge graph of a topic named “food tour”. The user device 100 may generate, based on the collected user data, a node of activity information indicating “staying”, a node of activity information indicating “eating”, and a node of activity information indicating “taking pictures”, may connect the nodes of the activity information, and may generate a personal knowledge graph of “well-known pizza restaurants”. The user device 100 may store and manage the generated personal knowledge graph in the knowledge graph-based personalized database.

As each node of activity information configuring a personal knowledge graph stores attribute data about a start time and an end time, the user device 100 may check whether there is an overlapping time among a plurality of pieces of activity information using the personal knowledge graph. When there is overlapping activity information in a same time period, the user device 100 may use attribute data of certain activity information as attribute data of other activity information. The user device 100 may infer, using a preset inference model, new information by collectively using user data at the level of raw data of various activity information from a plurality of pieces of activity information having an overlapping performance time period. For example, referring to FIG. 2B, the user device 100 may identify, based on the activity information indicating “staying”, that a user stayed in a place named “Italian Table” located in Gangnam-gu, Seoul, from 2:50 PM to 3:50 PM on May 18. The user device 100 may identify, based on the activity information indicating “eating”, that the user had a meal with a friend “Daniel”, from 3:00 PM to 3:50 PM on May 18. The user device 100 may identify, based on the activity information indicating “taking pictures”, that the user photographed multiple pictures related to a pizza, from 3:20 PM to 3:25 PM on May 18. By doing so, the user device 100 may infer that the user photographed pictures of a pizza while having the meal together with the friend “Daniel” in the place named “Italian Table” in Gangnam-gu, Seoul, from 3:20 PM to 3:25 PM on May 18. Therefore, when the user searches for a place where the user ate a pizza or a person who ate a pizza together, in the user device 100, the user may identify, using the personal knowledge graph of “well-known pizza restaurants”, that the place where the user ate a pizza is “Italian Table in Gangnam-gu, Seoul”, and the person who ate a pizza together is “friend Daniel”.

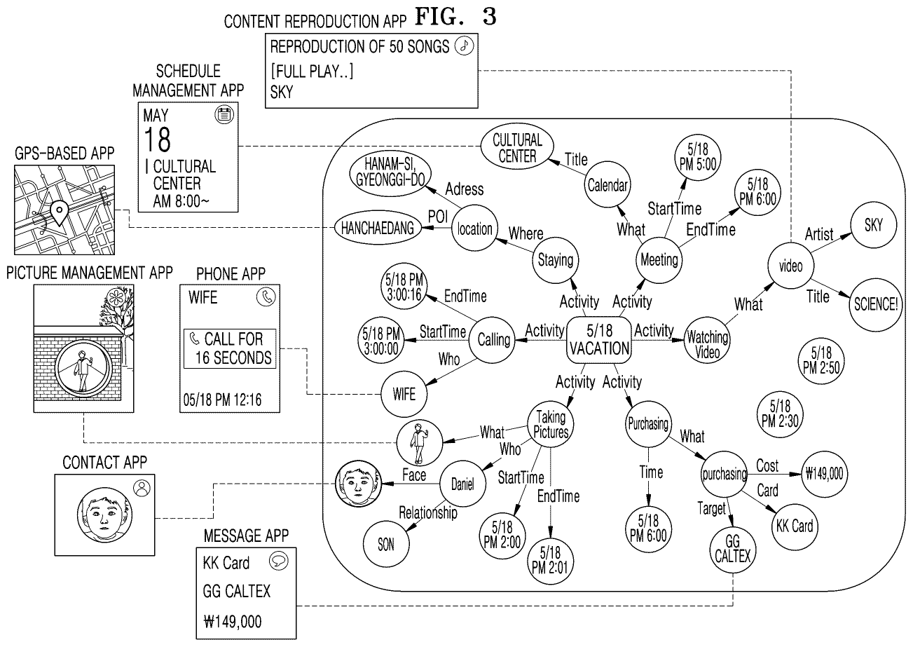

FIG. 3 is a diagram illustrating a personal knowledge graph generated in the user device 100 according to an embodiment of the disclosure.

The user device 100 according to an embodiment of the disclosure may collect user data related to each application and may classify the user data according to a preset reference. For example, the user device 100 may classify user data by clustering user data generated in similar time points or collected from similar places. The user device 100 may identify action information or activity information of a user from user data related to various applications, using action information ontology or activity information ontology. The user device 100 may obtain a personal knowledge graph including each node as the action information or the activity information of the user.

The user device 100 according to an embodiment of the disclosure may generate a personal knowledge graph in which nodes of activity information in a particular time period are connected. Referring to the personal knowledge graph shown in FIG. 3, it is shown that nodes of activity information generated based on user data generated on May 18 from among user data related to each application are connected.

According to each node in the personal knowledge graph, it is shown that a node of activity information indicating “watching video” is generated based on user data related to a title of a video reproduced via a content reproduction application, artist information, a reproduction start time, and a reproduction end time. It is shown that a node of activity information indicating “meeting” is generated based on user data related to a title of a scheduled recorded via a schedule management application, a schedule start time, and a schedule end time. It is shown that a node of activity information indicating “staying” is generated based on user data related to an address of a place and a place of interest recorded via a GPS-based application. It is shown that a node of activity information indicating “calling” is generated based on user data related to the other party who communicated with via a phone application, a call start time, and a call end time. It is shown that a node of activity information indicating “taking pictures” is generated based on user data related to pictures photographed via a picture management application, a photographing target, a photographing start time, and a photographing end time, and user data related to person information stored in a contact application. It is shown that a node of activity information indicating “purchasing” is generated based on user data related to payment information (payment target, credit card used in payment, amount of payment) and a payment time via a message application. It is shown that a plurality of pieces of activity information of respective nodes of the personal knowledge graph have a relationship of an activity occurred on May 18.

The user device 100 may use a personal knowledge graph for a service, and thus, may provide a user with a customized service and a personalized experience. As shown in FIG. 3, when a personal knowledge graph based on user data recognized as having a co-relationship is used for a service, it is possible to provide a service with enhanced quality due to removal of noise information or provide a new type of a service based on the user data recognized as having a co-relationship. Hereinafter, a method of generating a personal knowledge graph based on user data recognized as having a co-relationship, and a method of providing a service using a personal knowledge graph based on user data recognized as having a co-relationship will now be described.

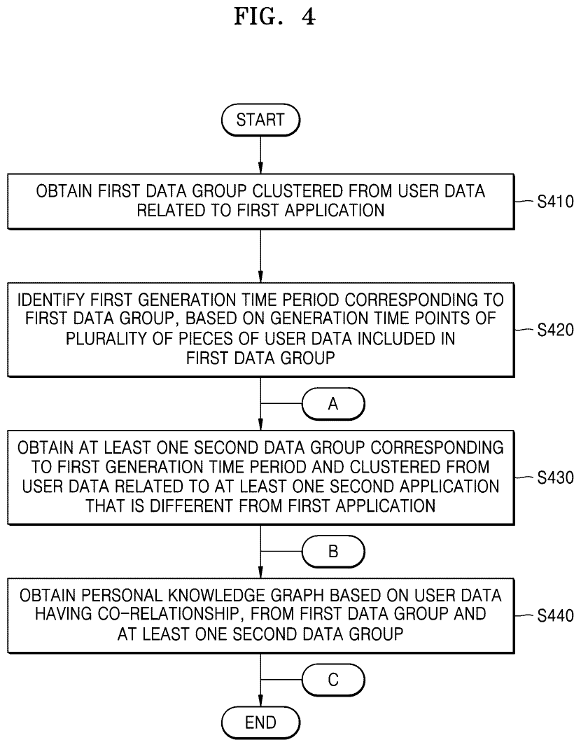

FIG. 4 is a flowchart illustrating a method of generating a personal knowledge graph, the method being performed by the user device 100 according to an embodiment of the disclosure.

Referring to FIG. 4, the user device 100 may obtain a first data group clustered from user data related to a first application (e.g., operation S410). The first application may be an application installed in the user device 1000, and may include a schedule management application, a chat application, a picture management application, a GPS-based application (e.g., map application), a social networking service (SNS) application, a health information management application, a message application, a phone application, a weather report application, a content reproduction application, or the like.

The first data group may include one or more pieces of user data. For example, when user data is a chat message, the user device 100 may cluster the chat message, based on information about a generation time point of the chat message or information about a chatting partner. The user device 100 may obtain, as the first data group, chat messages of a preset time period, based on respective generation time points of chat messages. The user device 100 may obtain, as the first data group, chat messages with respect to a particular partner, based on information about a chatting partner.

For example, when user data is a picture, the user device 100 may cluster the picture, based on at least one of information about a generation time point (time point of photographing) of the picture, information about a place where the picture was photographed, or information about a photographed object. The user device 100 may obtain, as the first data group, sequentially photographed pictures, based on the time point when the picture was photographed. The user device 100 may obtain, as the first data group, pictures photographed in the same place. The user device 100 may obtain, as the first data group, pictures including the same object, based on the photographed object. The user device 100 may obtain one picture as the first data group.

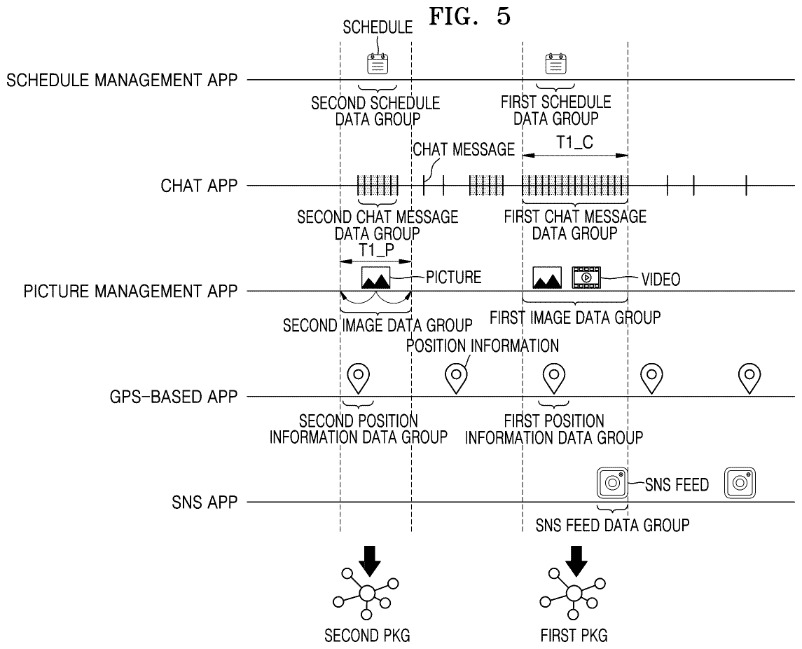

FIG. 5 is a diagram illustrating a first data group and a second data group which are clustered by the user device 100 from user data related to a plurality of applications according to an embodiment of the disclosure.

Referring to FIG. 5, user data generated by each of a schedule management application, a chat application, a picture management application, a GPS-based application, and an SNS application is shown. For example, when a user records a schedule, the schedule management application may generate schedule information. The chat application may generate a chat message while a user chats with a chatting partner. The picture management application may store a picture or a video which is generated when a user photographs the picture or captures the video. The GPS-based application may generate position information at regular time intervals. The SNS application may generate an SNS feed while a user uploads content to an SNS.

As illustrated in FIG. 5, in a case of a chat message related to the chat application, chat messages may be sequentially transmitted and received to and from a chatting partner, and a one-time message may be intermittently transmitted or received. In a case of the sequentially transmitted and received chatting messages or a chat message with a particular chatting partner, it is highly likely that they are user data having a co-relationship. The user device 100 may obtain a first chat message data group and a second chat message data group by clustering sequentially generated chatting messages or chat messages exchanged with a particular chatting partner during a preset time period from among chat messages.

In a case of a picture or a video which is related to the picture management application, there may be one-time picture or video photographing at a particular time or in a particular place, or pictures may be sequentially photographed or both a picture and a video may be photographed. In a case of a picture and a video, one-time photographing may be important, and thus, it is necessary to process even one picture as a data group. The user device 100 may obtain a first image data group and a second image data group by clustering one or more pictures or videos.

In a case of schedule information related to the schedule management application, position information related to the GPS-based application, and information about an SNS feed related to the SNS application, the user device 100 may obtain a data group by clustering one or more pieces of user data.

The user device 100 may obtain, as a first data group, an arbitrary data group from among clustered data groups. For example, the user device 100 may obtain, as the first data group, the arbitrary data group clustered from user data related to an arbitrary application.

Referring back to FIG. 4, the user device 100 may identify a generation time period corresponding to the first data group (hereinafter, the first generation time period), based on generation time points of a plurality of pieces of user data included in the first data group (e.g., operation S420).

For example, the user device 100 may identify, as the first generation time period, a time period from a generation time point of user data that is first generated from among the plurality of pieces of user data included in the first data group to a generation time point of user data that is last generated. Referring back to FIG. 5, the user device 100 may obtain, as the first data group, the first chat message data group clustered from user data related to the chat application. The user device 100 may determine, as a first generation time period T1_C, a time period from a generation time point of a chat message that is first generated from among chat messages included in a first chat message data group to a generation time point of a chat message that is last generated.

For example, the user device 100 may identify, as the first generation time period, a time period from a generation time point of user data included in the first data group to a preset time point. Referring back to FIG. 5, the user device 100 may obtain, as the first data group, the second image data group clustered from user data related to the picture management application. The user device 100 may determine, as a first generation time period T1_P, a time period from a generation time point of a picture included in the second image data group to a preset time point.

Referring back to FIG. 4, the user device 100 may obtain at least one second data group corresponding to a first generation time period and clustered from user data related to at least one second application that is different from the first application (e.g., operation S430).

Referring back to FIG. 5, when the user device 100 obtains the first chat message data group as the first data group, the user device 100 may obtain, as the second data group, a first schedule data group, a first image data group, a first position information data group, and an SNS feed data group which are generated in the first generation time period T1_C corresponding to the first chat message data group. Respective generation time periods of the first schedule data group, the first image data group, the first position information data group, and the SNS feed data group which are generated in the first generation time period T1_C corresponding to the first chat message data group do not exceed a range of the first generation time period T1_C corresponding to the first chat message data group.

When the user device 100 obtains the second image data group as the first data group, the user device 100 may obtain, as the second data group, a second schedule data group, a second chat message data group, and a second position information data group which are generated in the first generation time period T1_P corresponding to the second image data group. Respective generation time periods of the second schedule data group, the second chat message data group, and the second position information data group which are generated in the first generation time period T1_P corresponding to the second image data group do not exceed a range of the first generation time period T1_C corresponding to the second image data group.

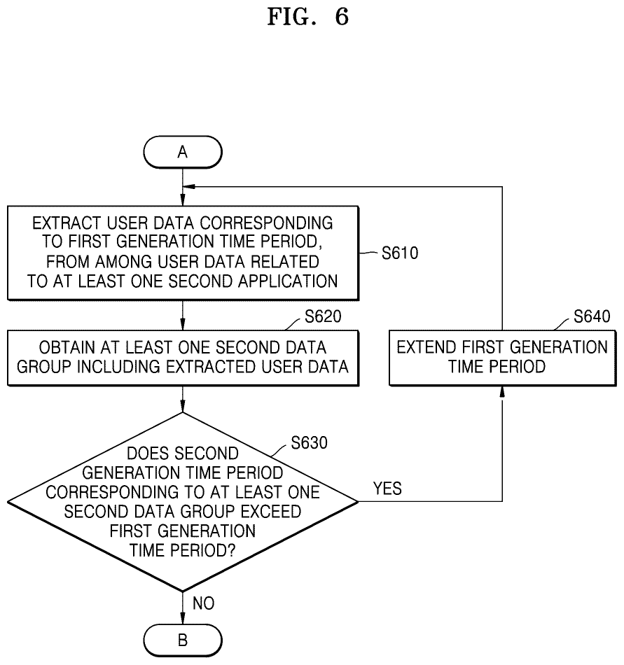

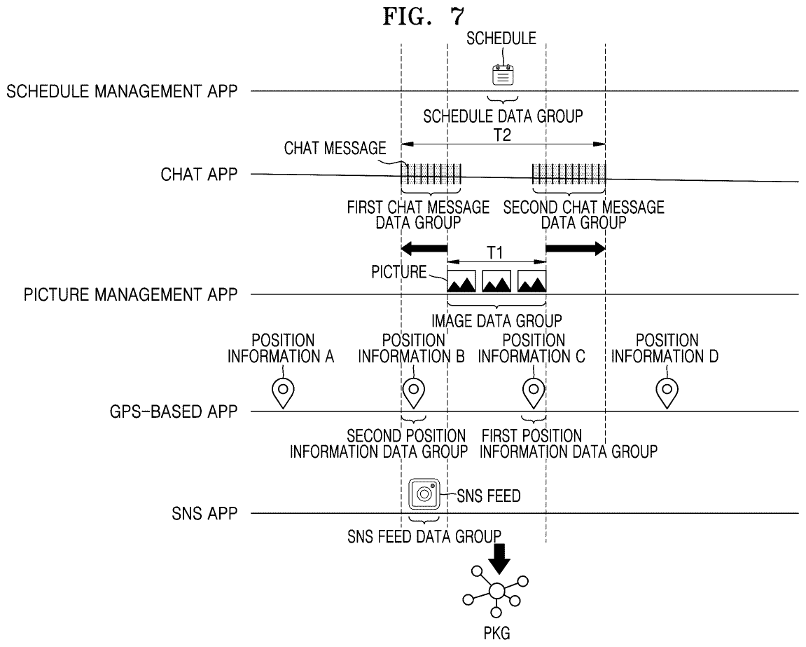

When a second generation time period corresponding to a second data group exceeds a range of a first generation time period corresponding to a first data group, the user device 100 may obtain an extended second data group by extending the range of the first generation time period. This will now be described in detail with reference to FIGS. 6 and 7.

FIG. 6 is a flowchart illustrating a process in which the user device 100 extends and obtains a second data group, according to an embodiment of the disclosure.

Referring to FIG. 6, the user device 100 may extract user data corresponding to the first generation time period corresponding to the first data group, from among user data related to at least one second application (e.g., operation S610). When user data related to the second application is continued to be generated before a start time and after an end time of the first generation time period corresponding to the first data group, the user device 100 may even extract continued generated user data that exceeds the first generation time period corresponding to the first data group.

The user device 100 may obtain at least one second data group by clustering the extracted user data related to the at least one second application, based on generation time point information (e.g., operation S620). The at least one second data group may include at least one data group related to the second application and at least one data group related to a third application.

The user device 100 may determine whether the second generation time period corresponding to the at least one second data group exceeds the first generation time period (e.g., operation S630). The user device 100 may identify whether a range of the first generation time period corresponding to the first data group is exceeded, by checking a time period from a generation time point of user data that is first generated from among the plurality of pieces of user data included in the at least one second data group to a generation time point of user data that is last generated. The user device 100 may identify whether a range of a generation time period of the at least one data group related to the second application and a range of a generation time period of the at least one data group related to the third application exceed a range of the first generation time period corresponding to the first data group related to the first application.

When the second generation time period corresponding to the at least one second data group exceeds the first generation time period, the user device 100 may extend the first generation time period, based on the second generation time period (e.g., operation S640). The user device 100 may repeat a process of obtaining the at least one second data group with respect to the extended first generation time period. When the second generation time period corresponding to the at least one second data group does not exceed the first generation time period, the user device 100 may end a process of obtaining the at least one second data group.

FIG. 7 is a diagram illustrating the user device 100 that extends a second data group, according to an embodiment of the disclosure.

Referring to FIG. 7, the user device 100 may obtain an image data group (first data group) clustered from user data related to a picture management application (first application). The user device 100 may identify a first generation time period T1 corresponding to the image data group. The user device 100 may obtain a schedule data group that corresponding to the first generation time period T1 and is clustered from schedule information related to a schedule management application. The user device 100 may obtain a first chat message data group and a second chat message data group which are clustered from chat messages related to a chat application and correspond to the first generation time period T2. The user device 100 may obtain a first position information data group that is clustered from position information related to a GPS-based application and corresponds to the first generation time period T1. As there is no information about an SNS feed that is related to an SNS application and corresponds to the first generation time period T1, the user device 100 cannot obtain an SNS feed data group corresponding to the first generation time period T1, from information about an SNS feed related to the SNS application. Accordingly, the user device 100 may obtain, as a second data group, the schedule data group, the first chat message data group, the second chat message data group, and the first position information data group which correspond to the first generation time period T1.

In this regard, it is possible to identify that a generation time period corresponding to the first chat message data group and a generation time period corresponding to the second chat message data group exceed the first generation time period T1 that corresponds to the image data group. The user device 100 may extend the first generation time period T1 to a new first generation time period T2, based on the generation time period corresponding to the first chat message data group and the generation time period corresponding to the second chat message data group. The user device 100 may obtain at least one second data group corresponding to the extended first generation time period T2.

The user device 100 may obtain a schedule data group that is clustered from the schedule information related to the schedule management application and corresponds to the extended first generation time period T2. The user device 100 may obtain a first chat message data group and a second chat message data group which are clustered from chat messages related to the chat application and correspond to the extended first generation time period T2. The user device 100 may obtain a first position information data group and a second position information data group which are clustered position information related to the GPS-based application and correspond to the extended first generation time period T2. The user device 100 may obtain an SNS feed data group that is clustered from information about an SNS feed related to the SNS application and corresponds to the extended first generation time period T2. As a result, as it is changed from the previous first generation time period T1 to the extended first generation time period T2, the user device 100 may further obtain the second position information data group and the SNS feed data group as the second data group.

Referring back to FIG. 4, the user device 100 may obtain a personal knowledge graph based on user data having a co-relationship, from the first data group and the at least one second data group (e.g., operation S440).

The co-relationship means that a certain relationship is formed or exists between a plurality of pieces of user data. For example, when ‘user data A’ has a preceding-following or causal relationship with ‘user data B’, based on a particular time point, ‘user data A’ and ‘user data B’ may be recognized as having a co-relationship. When ‘user data C’ and ‘user data D’ have common attributes such as being related to the same object or being generated at the same place, ‘user data C’ and ‘user data D’ may be recognized as having a co-relationship.

The personal knowledge graph based on user data may be used to indicate characteristics, tendencies, preferences, likings, etc. of a user or to describe a particular event related to the user. The personal knowledge graph based on user data recognized as having a co-relationship may be an optimized personal knowledge graph to provide a knowledge graph-based customized service.

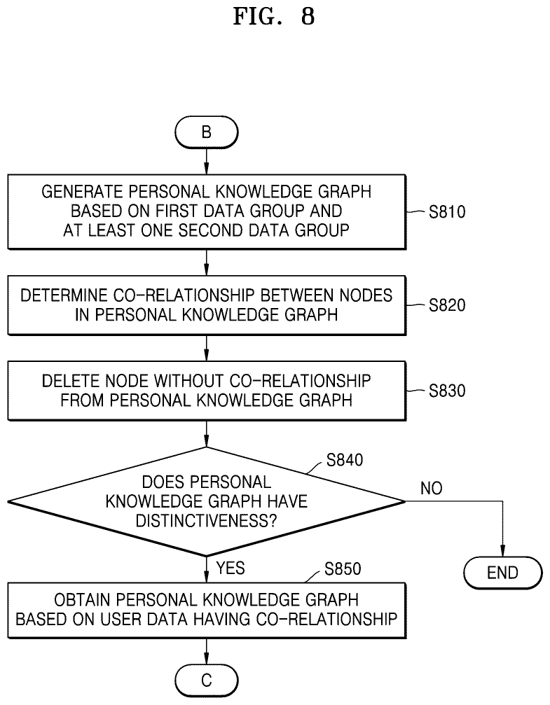

FIG. 8 is a flowchart illustrating a process of obtaining, by the user device 100, a personal knowledge graph based on user data having a co-relationship, according to an embodiment of the disclosure.

Referring to FIG. 8, the user device 100 may generate a personal knowledge graph based on a first data group and at least one second data group (e.g., operation S810). The user device 100 may obtain action information or activity information based on all user data included in the first data group and the at least one second data group, may connect nodes with each other using the action information or the activity information, may store attribute information of each node, and thus, may generate the personal knowledge graph.

The user device 100 may determine a co-relationship between nodes in the personal knowledge graph (e.g., operation S820). The user device 100 may determine a co-relationship between nodes, based on at least one of whether a node connected to a first node based on the user data of the first data group exists (first determination reference), the number of nodes connected to the first node (second determination reference), whether a node connected to a second node connected to the first node exists (third determination reference), or the number of nodes connected to the second node (fourth determination reference).

The user device 100 may obtain the co-relationship between the nodes, based on an output value of a preset function or a preset learning model which receives at least one of quantified values according to each determination reference as an input. The preset function may be a function for outputting a certain value via a preset calculation or selecting a certain value, according to a preset rule from among quantified values according to a determination reference. Alternatively, the preset function may determine an average such as an arithmetic mean, a harmonic mean, a geometric mean, or a weighted mean of the quantified values according to the determination reference, or may output a minimum or maximum value. Alternatively, the preset function may be a function for outputting a result of a preset calculation by receiving at least one of the quantified values according to the determination reference as an input. The preset learning model may be a deep learning model or machine-learning model type co-relation determination mode that receives at least one of the quantified values according to the determination reference as an input. However, when the user device 100 does not determine a quantified value according to all determination references, the user device 100 may determine a predefined preset value as a value that indicates the co-relationship.

The user device 100 may delete a node without the co-relationship from the personal knowledge graph (e.g., operation S830). The user device 100 may delete, from the personal knowledge graph, a node in which a value indicating the co-relationship is less than a preset reference and nodes with lower levels.

The user device may determine whether there is distinctiveness of the personal knowledge graph (e.g., operation S840). The user device 100 may generate, from user data of each node reflected to the personal knowledge graph, sentences to be input to a large language model (LLM) or a machine-learning based model for determining distinctiveness. The user device 100 may input the generated sentences to the LLM or the machine-learning based model for determining distinctiveness, and thus, may determine whether there is distinctiveness of the personal knowledge graph and may determine a topic or a title of the personal knowledge graph.

When there is distinctiveness of the personal knowledge graph, the user device may store the personal knowledge graph based on user data having a co-relationship (e.g., operation S850). When it is determined that the personal knowledge graph based on user data having a co-relationship does not have distinctiveness of the personal knowledge graph, the user device 100 does not store the personal knowledge graph.

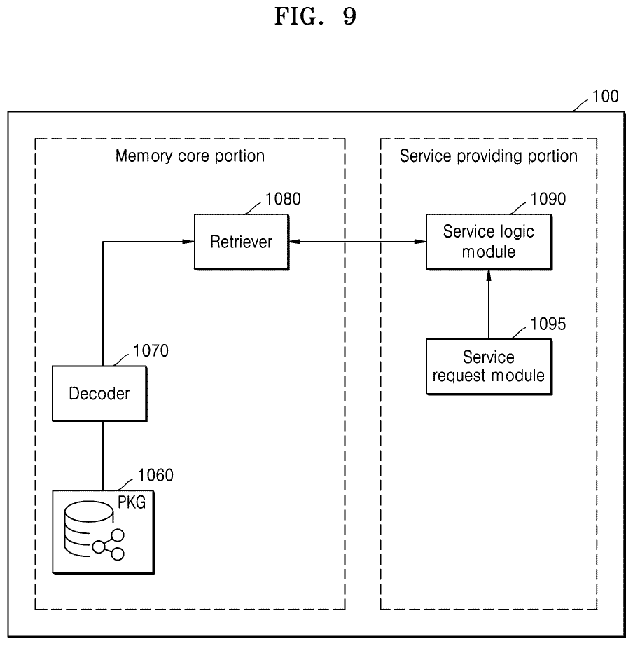

FIG. 9 is a diagram illustrating an operation in which the user device 100 provides a personal knowledge graph-based service, according to an embodiment of the disclosure.

According to an embodiment of the disclosure, in a service providing portion of the user device 100, a service logic module 1090 may execute a preset service, according to a user input via a service request module 1095. The service request module 1095 may receive a user input such as a request to execute a preset application, a keyword input, or a touch on a user interface screen for setting a particular item, character, number, or time period. For example, the service logic module 1090 may request a retriever 1080 for a related personal knowledge graph or user data of the personal knowledge graph, according to a request to execute a preset application or a keyword input which is input from a user. The service logic module 1090 may provide the preset service using the personal knowledge graph based on user data having a co-relationship or the user data obtained from the personal knowledge graph.

In a memory core portion of the user device 100, the retriever 1080 may retrieve a personal knowledge graph stored in the storage 1060 or may search for user data included in the personal knowledge graph. The retriever 1080 may include a retrieve engine or a search engine. The retriever 1080 may retrieve personal knowledge graphs for each date or personal knowledge graphs during a particular date or period, and may transmit a retrieval result to the service logic module 1090. The retriever 1080 may search for, in the storage 1060, a personal knowledge graph or user data included in the personal knowledge graph corresponding to a keyword or query, and may transmit a search result to the service logic module 1090. The retriever 1080 may identify an internationalized resource identifier (IRI) of a representative term with respect to an input keyword using an embedding vector comparison method or a synonym dictionary database (DB). The retriever 1080 may configure a query using the IRI, and may receive a result of the query with respect to a personal knowledge graph from the storage 1060.

A decoder 1070 performs an inverse role of the encoder 1050 of FIG. 2A. The decoder 1070 may obtain data usable in the service logic module 1090, from structured data obtained from the personal knowledge graph.

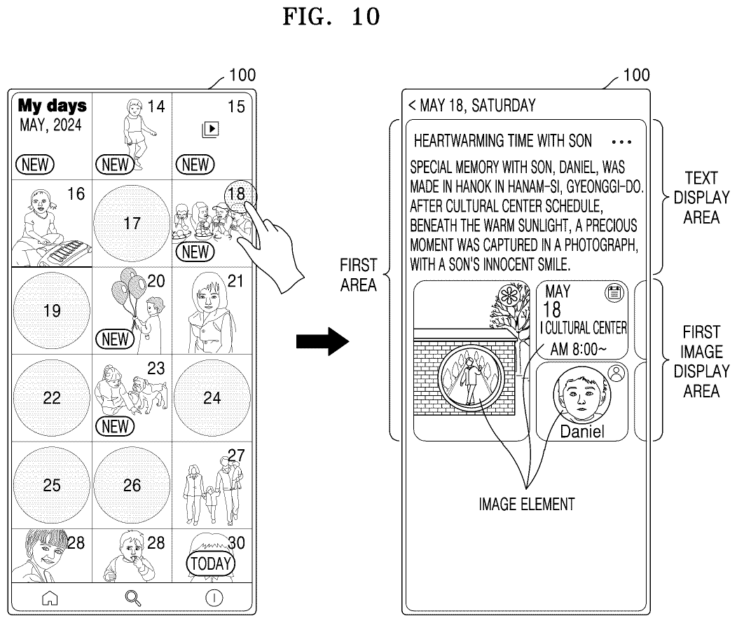

FIG. 10 is a diagram illustrating a home screen and a journal provision screen of a journal application executed in the user device 100 according to an embodiment of the disclosure.

The user device 100 may execute the journal application, according to a user input. The journal application may be installed in the user device 100, may process and determine user data stored in the user device 100, and may generate a journal. The user device 100 may generate the journal using a personal knowledge graph based on user data having a co-relationship, via the journal application.

Referring to FIG. 10, the home screen of the journal application provided to a display screen of the user device 100 is shown. The home screen of the journal application may provide a representative image related to a journal for each date, thereby information whether there is a journal generated on each date. For example, as illustrated in FIG. 10, the home screen of the journal application may display a preview image related to the journal on a particular date, in a case where the journal has been generated for the date within a preset period in the past from today. When there is no journal generated for each date, the home screen of the journal application may display only a corresponding date, without a preview image.

The user device 100 may switch from the home screen of the journal application to the journal provision screen, according to a user input. When there is a user input of selecting a particular date from the home screen of the journal application, the user device 100 may provide the journal provision screen to a display screen so as to display a journal corresponding to the particular date. For example, as shown in FIG. 10, when there is a user input of selecting a representative image corresponding to the 18^{th} day from the home screen of the journal application, the user device 100 may display a journal corresponding to the 18^{th} day via the journal provision screen.

Referring to FIG. 10, the journal may be output to a first area of the display screen. The first area may correspond to one area of the display screen that is divided into a preset number of areas. For example, when the display screen is vertically or horizontally divided into two areas, the first area may be one of the two areas of the divided display screen.

The first area of the display screen is a journal area for providing a journal. The first area of the display screen may be an area corresponding to a portion of the entire display screen. The first area of the display screen may be an area with a predefined size or an area with a variable size that may vary according to content of a generated journal. The first area may be configured with a text display area and a first image display area. A position, a size, a shape, a style, or the like of the text display area and the first image display area may be changed according to a generated journal.

The text display area may output content of a journal with a title of the journal as a text on the top of the first area. The title of the journal and the content of the journal may have been generated using first user data extracted from a personal knowledge graph based on user data having a co-relationship.

The first image display area may output a first image based on the first user data used to generate the journal. The first user data may be configured with at least one user data, and the first image may be configured with at least one image element.

Referring to FIG. 10, the first image may be configured with a plurality of image elements, and each image element may be an image, a picture, a graphic, or the like. Each image element may be displayed in a different size according to a degree to which user data corresponding to each image element is related to content of a journal. Each image element may be displayed in a manner that ensures a minimum size sufficient for a user to identify it with the user's eye. When not all image elements can be displayed in the first image display area of the display screen, all the image elements may be identified through horizontal or vertical scrolling.

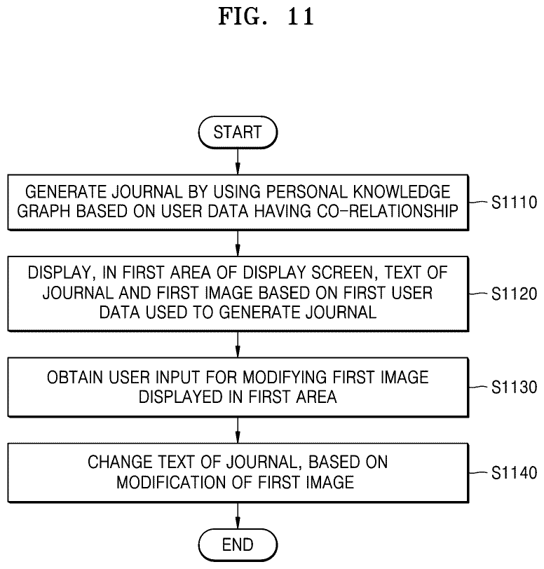

FIG. 11 is a flowchart illustrating a method of providing a personal knowledge graph-based journal, according to an embodiment of the disclosure.

Referring to FIG. 11, the user device may generate a journal using a personal knowledge graph based on user data having a co-relationship (e.g., operation S1110). The user device 100 may obtain a sentence-form text of a journal using a journal generation model receiving an input of the personal knowledge graph based on user data having a co-relationship. The journal generation model may correspond to the LLM capable of outputting a sentence-form text of a journal corresponding to first user data by receiving an input of user data (the first user data) corresponding to a part or all of user data used to generate the personal knowledge graph. The user device 100 may obtain the text of the journal corresponding to the first user data, and a first image based on the first user data.

The user device 100 may display, in a first area of a display screen, the text of the journal and the first image based on the first user data used to generate the journal (e.g., operation S1120). The first user data may be user data extracted from the personal knowledge graph, based on a reference such as the level of co-relationship between user data, a generation time point, a position, and a target of the user data. The first user data may include a plurality of pieces of user data. The first image may include a plurality of image elements corresponding to the plurality of pieces of user data. The first image may include an image element including a representative image such as a thumbnail, a preview, etc., a picture, a graphical image, or the like.

For example, the first user data may be at least one activity information obtained from a personal knowledge graph based on activity information having a co-relationship. The first image may be represented as image elements including a representative image, a picture, a graphical image, etc., based on the at least one activity information. Alternatively, the first image may include a knowledge graph including the at least one activity information as a node. Each node of the knowledge graph may be represented as an image element including a representative image, a picture, a graphical image, etc., based on the activity information.

The user device may obtain a user input for modifying the first image displayed in the first area (e.g., operation S1130). The user device 100 may obtain the user input for modifying the first image. The user input for modifying the first image may correspond to modification of any one of a plurality of image elements constituting the first image. For example, the user input for modifying the first image may correspond to modification of the first image by changing at least one of a type, a position, a state, or the number of image elements constituting the first image. When the first image includes a knowledge graph based on action information corresponding to an operation of the user and activity information configured with a plurality of pieces of sequential action information, a user input for modifying the first image may correspond to modification of the knowledge graph by changing at least one of a type, a position, a state, or the number of nodes of the knowledge graph.

The user device 100 may change the text of the journal, based on modification of the first image displayed in the first area (e.g., operation S1140). The user device 100 may change the text of the journal, based on a change in at least one of a type, a position, a state, or the number of image elements constituting the first image. According to the change in the first image, the first user data of the personal knowledge graph which is used to generate the journal may be changed, and moreover, the personal knowledge graph may also be changed. The user device 100 may obtain a text of the changed journal using the journal generation model receiving an input of the first user data changed according to the change in the first image. The journal generation model may output a sentence-form text of the journal corresponding to the changed first user data, by receiving an input of the first user data changed in response to the changed first user data.

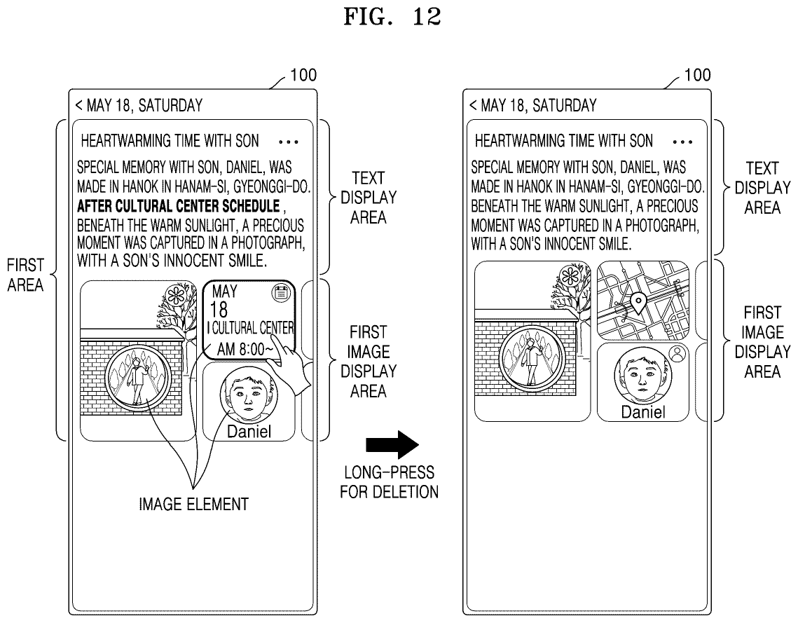

FIG. 12 is a diagram illustrating a process of editing, by the user device 100, a journal by changing a first image, according to an embodiment of the disclosure.

The user device 100 may generate a journal using a personal knowledge graph based on user data having a co-relationship, and may display, in a first area of the display screen, a text of the journal and a first image based on first user data used to generate the journal. The first image may include a plurality of image elements corresponding to a plurality of pieces of user data, and each image element may be an image, a picture, a graphical image, or the like.

According to an embodiment of the disclosure, the user device 100 may obtain a user input of selecting a first image element from among the image elements constituting the first image. For example, a user may tap or double-tap a touch screen of the user device 100, thereby selecting the first image element from among the image elements output to a first image display area. The first image element may be adjusted with respect to a color, brightness, contrast, etc., so as to be distinguishable from other image elements so as to indicate a selected state to the user.

The user device 100 may change the text of the journal such that a text corresponding to the first image element may be identified from the text of the journal. In response to the user input of selecting the first image element, the user device 100 may change the text of the journal such that the text corresponding to the first image element to be displayed is distinguishable from other text in the text of the journal. For example, the user device 100 may output the text by adjusting a color, brightness, contrast, etc. such that the text corresponding to the first image element and selected from the text of the journal is distinguishable from other text, using the journal generation model receiving an input of the first user data changed according to a changed state of the first image element.

Referring to FIG. 12, the user device 100 may obtain a user input of selecting an image related to a cultural center schedule from among the image elements constituting the first image, and may change a color of a corresponding portion of the text of the journal so that a text corresponding to the cultural center schedule is identifiable.

According to an embodiment of the disclosure, the user device may obtain a user input of deleting the first image element from among the image elements constituting the first image. For example, the user long-presses the first image element via the touch screen of the user device 100, thereby deleting the first image element from among the image elements output to the first image display area. The deleted first image element may be replaced by other image element.

The user device 100 may change the text of the journal such that the text corresponding to the first image element is deleted from the text of the journal. In response to the user input of deleting the first image element, the user device 100 may change the text of the journal such that the text corresponding to the first image element is excluded from content of the journal. For example, the user device 100 may change the text of the journal such that the text corresponding to the deleted first image element is deleted, using the journal generation model receiving an input of the first user data changed according to deletion of the first image element.

Referring to FIG. 12, the user device 100 may obtain a user input of long-pressing and deleting an image related to the cultural center schedule from among the image elements constituting the first image, and may modify the content of the journal by deleting the text corresponding to the cultural center schedule from the text of the journal.

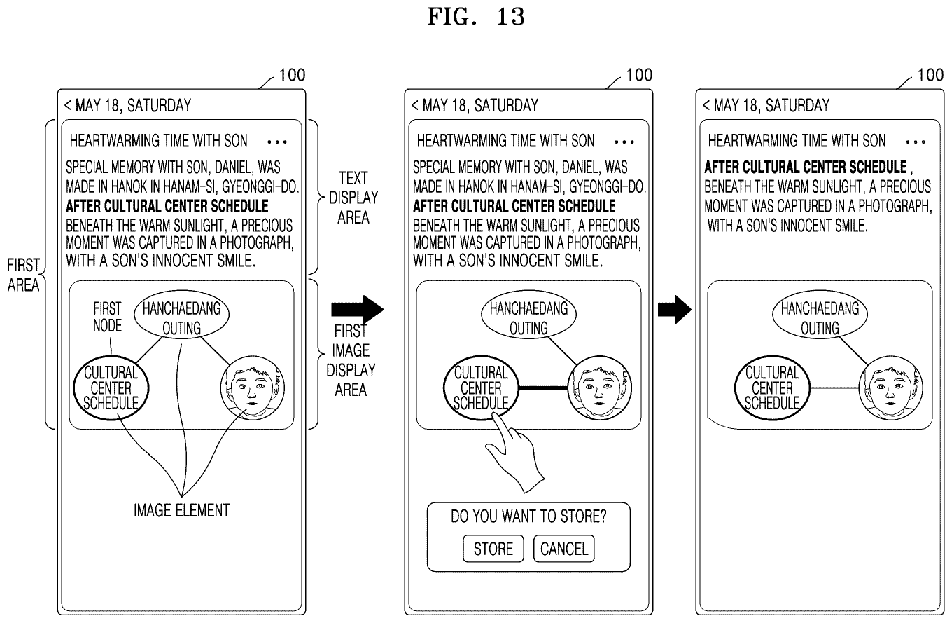

FIG. 13 is a diagram illustrating a process, performed by the user device 100, for modifying a first image and editing a journal, according to an embodiment of the disclosure.

The user device 100 may generate a journal using a personal knowledge graph based on user data having a co-relationship, and may display, in a first area of the display screen, a text of the journal and a first image based on first user data used to generate the journal. The first user data may be action information and activity information obtained from the personal knowledge graph. The first image may include a knowledge graph based on the action information or the activity information. Each node of the knowledge graph may be represented as an image element such as an image, a picture, a graphical image, etc., based on the action information or the activity information.

Unlike the first image of FIG. 12, which displays image elements such as images, pictures, and graphical images arranged in a list format, the first image of FIG. 13 may include the knowledge graph based on the activity information. Each node of the knowledge graph may correspond to an image element such as an image, a picture, a graphical image, etc., based on the activity information.

According to an embodiment of the disclosure, in a case where the journal is generated using the personal knowledge graph based on user data having a co-relationship and then a text of the journal is directly input, according to a user input, the user device 100 may display an image element corresponding to the directly input text such that the image element becomes a first node of the knowledge graph based on the first user data used to generate the journal. The first node may be adjusted with respect to a color, brightness, contrast, etc., so as to be distinguishable from other nodes of the knowledge graph.

According to an embodiment of the disclosure, the user device 100 may obtain a user input of moving, in the first area, a position of the first node of the knowledge graph. For example, the user device 100 may receive a user input of dragging the first node via the touch screen, and may display the first node by changing its position according to the dragging direction. In response to the user input of moving the position of the first node, the user device 100 may display an edge between the first node and at least one node of the knowledge graph, based on a co-relationship between the first node and other nodes of the knowledge graph. For example, when the first node has a higher co-relationship with a third node than a second node of the knowledge graph, the user device 100 may display an edge connecting the first node and the third node as a thicker or darker line than an edge connecting the first node and the second node. A user may drag and drop the first node to a position where an edge is formed from another node of the knowledge graph to the first node.

The user device 100 may change the text of the journal, based on a change in the knowledge graph according to the changed position of the first node. In response to the user input of moving the position of the first node in the first area, the user device 100 may change the text of the journal, based on a change in the knowledge graph according to the changed position of the dragged and dropped first node.

For example, as shown in FIG. 13, when the user drags and drops the first node related to cultural center schedule information from among nodes of the knowledge graph, the user device 100 may change the text of the journal, based on a change in the knowledge graph according to the changed position of the first node. The user device 100 may use the journal generation model that receives an input of the knowledge graph changed according to the changed position of the first node (or a connection relationship with another node). In the example of FIG. 13, as the first node is moved and the nodes that were connected around a node corresponding to “Hanchaedang outing” become connected around a node representing a picture of a son's face, the user device 100 may change the content and the order of text of the journal.

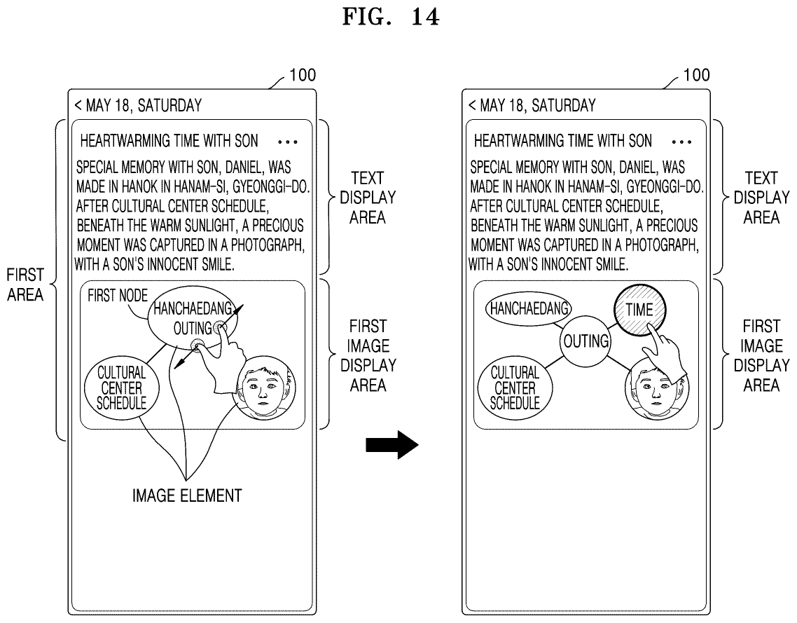

FIG. 14 is a diagram illustrating a process, performed by the user device 100, for modifying a first image and editing a journal, according to an embodiment of the disclosure.

The user device 100 may generate a journal using a personal knowledge graph based on user data having a co-relationship, and may display, in a first area of the display screen, a text of the journal and a first image based on first user data used to generate the journal. The first user data may be action information and activity information obtained from the personal knowledge graph. The first image may include a knowledge graph based on the action information or the activity information. Each node of the knowledge graph may be represented as an image element such as an image, a picture, a graphical image, etc., based on the action information or the activity information.

The first image of FIG. 14 may include a knowledge graph based on the activity information. Each node of the knowledge graph may correspond to an image element such as an image, a picture, a graphical image, etc., based on the activity information.

According to an embodiment of the disclosure, the user device 100 may receive a user input for modifying user data related to a first node of a knowledge graph. For example, the user device 100 may receive a user input of spreading the first node via the touch screen, and may change and display the first node as a plurality of sub-nodes, each representing the user data. A user may select a sub-node corresponding to user data to be modified, and thus, may modify the user data or may delete or add a sub-node.

The user device 100 may change the text of the journal, based on a change in the knowledge graph according to the modified user data. In response to the user input for modifying the user data corresponding to the first node, the user device 100 may change the text of the journal, based on the change in the knowledge graph according to the modified user data.

For example, as shown in FIG. 14, in a case where the user selects a first sub-node from among the sub-nodes of the first node and modifies time information so as to modify user data related to the time information, the user device 100 may change the text of the journal, based on a change in the knowledge graph according to the modified time information, using the journal generation model receiving an input of user data having reflected thereto the modified time information. In the example of FIG. 14, when the time information of the outing is modified to a time earlier than the cultural center schedule, the content of the journal may be changed to indicate that the cultural center schedule was carried out after the outing.

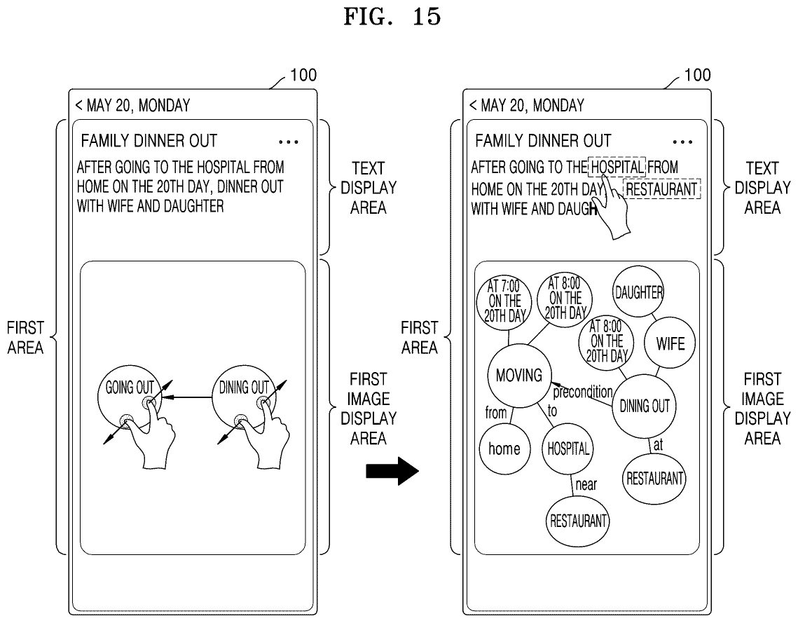

FIG. 15 is a diagram illustrating a process, performed by the user device 100, of editing a journal by modifying a text of the journal, according to an embodiment of the disclosure.

The user device 100 may generate a journal using a personal knowledge graph based on user data having a co-relationship, and may display, in a first area of the display screen, a text of the journal and a first image based on first user data used to generate the journal. The first user data may be action information and activity information obtained from the personal knowledge graph. The first image may include a knowledge graph based on the action information or the activity information. Each node of the knowledge graph may be represented as an image element such as an image, a picture, a graphical image, etc., based on the action information or the activity information.

The first image of FIG. 15 may include a knowledge graph that is based on the activity information. Each node of the knowledge graph may correspond to an image element such as an image, a picture, a graphical image, etc., based on the activity information. In the example of FIG. 15, the content of the journal describing an outing and having a family dinner is output as a text together with a title of the journal “Family Dinner Out,” is output to a text display area. The first image displays a knowledge graph including a first node and a second node respectively corresponding to activity information used to generate the journal “going out” and “dining out”.

According to an embodiment of the disclosure, the user device 100 may obtain a user input of spreading each node of the knowledge graph represented by the first image via the touch screen. In response to the user input, the user device 100 may change and display each of the first node and the second node as a plurality of sub-nodes having a lower-level structure, thereby exposing detailed user data corresponding to “going out” and “dining out”, respectively. In the example of FIG. 15, detailed user data related to the activity information “going out,” such as the start time of the movement, the end time of the movement, the departure place, the arrival place, and nearby places around the arrival place, may be represented as a plurality of sub-nodes. Related to the activity information “dining out,” detailed user data such as the time of dining, the person who dined together, and the dining place may be represented as a plurality of sub-nodes. The user device 100 may identify that the first node, “going out,” corresponds to activity information that serves as a prerequisite for the second node, “dining out.”

The user device 100 may map a text of user data text in the knowledge graph to a corresponding IRI and may manage it as a mapping table. The user device 100 may configure a query using the IRI related to a word or sentence selected by the user and may perform a relational search to receive query results from the knowledge graph. When the user selects a word or sentence, the user device 100 may obtain recommended words or recommended sentences from the knowledge graph via the relational search.

In the example of FIG. 15, as the user actually parked in the parking lot of the hospital building and then moved to a restaurant, navigation information collected by the user device 100 results in the journal recording the sequence as traveling to the hospital and then dining out. In context, it would be more natural to correct “hospital” to “restaurant” in the journal, and thus, the user may attempt to modify the text of the journal. When the user taps the text the user attempts to modify, the user device 100 may provide alternative words or sentences based on the knowledge graph in a dropdown menu or a new window. The user device 100 may change the text of the journal, according to the user input of changing the text.

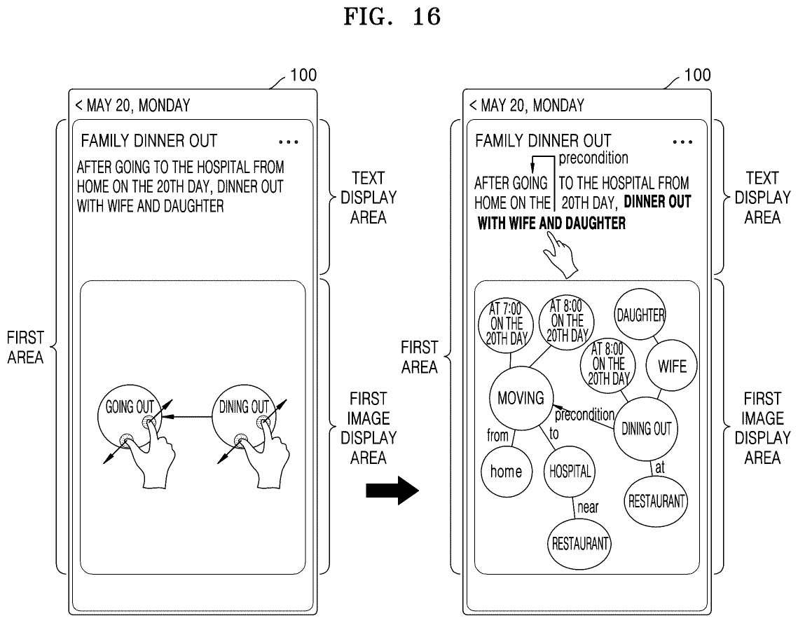

FIG. 16 is a diagram illustrating a process, performed by the user device 100, of editing a journal by modifying a text of the journal, according to an embodiment of the disclosure.

Description of aspects that are the same as or similar to those described above may be omitted.

Referring to FIG. 16, as a first node, “going out,” corresponds to activity information that serves as a prerequisite for a second node, “dining out,” the user device 100 may identify that a sentence based on the activity information “going out” corresponding to the first node is in a relationship of being a prerequisite for a sentence based on the activity information “dining out” corresponding to the second node.

According to an embodiment of the disclosure, the user device 100 may obtain a user input of long-pressing and selecting a sentence based on the activity information “dining out” via the touch screen. In response to the user input, the user device 100 may display that the sentence based on the activity information “dining out” and the sentence based on the activity information “going out” are in a prerequisite relationship. When a user deletes the sentence based on the activity information “dining out,” the user device 100 may request a feedback from the user on whether to delete or maintain the sentence based on the activity information “going out,” which is in the prerequisite relationship. The user device 100 may delete a sentence related to the sentence selected and deleted by the user, from the journal together via a relational search.

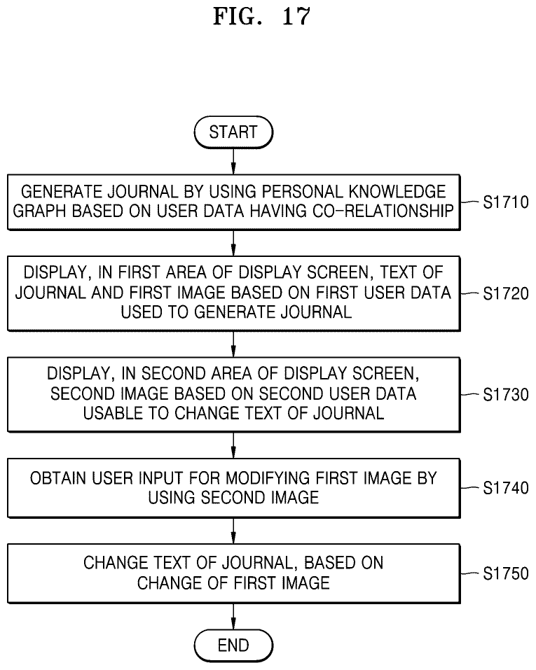

FIG. 17 is a flowchart illustrating a method of providing a personal knowledge graph-based journal, according to an embodiment of the disclosure. Description of aspects that are the same as or similar to those described above may be omitted.

Referring to FIG. 17, the user device 100 may generate a journal using a personal knowledge graph based on user data having a co-relationship (e.g., operation S1710). The user device 100 may generate the journal using the personal knowledge graph based on user data having a co-relationship, via the journal generation model.

The user device 100 may display, in a first area of a display screen, the text of the journal and the first image based on the first user data used to generate the journal (e.g., operation S1720). The user device 100 may obtain the text of the journal corresponding to the first user data obtained from the personal knowledge graph and the first image based on the first user data, and may output the text and the first image to the first area of the display screen.

The user device 100 may display, in a second area of the display screen, a second image based on second user data usable to change the text of the journal (e.g., operation S1730).

The user device 100 may obtain the second user data from the personal knowledge graph. The second user data may be user data that is related to the first user data but was not used to generate the journal. The second user data may be user data related to a text that is addible to the journal. The second user data may be candidate user data that is usable to add or modify a text of the journal. The second user data may be remaining user data excluding the first user data extracted from the personal knowledge graph. The second user data may include a plurality of pieces of user data. The second image may include a plurality of image elements corresponding to the plurality of pieces of user data. The second image may include an image element including a representative image such as a thumbnail, a preview, etc., a picture, a graphical image, or the like.

For example, the second user data may be at least one activity information obtained from a personal knowledge graph based on activity information having a co-relationship, and may be candidate activity information usable to change the text of the journal. The second image may be represented as image elements including an image, a picture, a graphical image, etc., based on the at least one activity information. Alternatively, the second image may be represented as image elements corresponding to the action information or the activity information based on the second user data, and may be an image, a picture, a graphical image, etc., based on the action information or the activity information.

The user device 100 may obtain a user input for modifying the first image using the second image (e.g., operation S1740).

The user input for modifying the first image may correspond to modification of the first image using any one of a plurality of image elements constituting the second image. For example, the user input for modifying the first image may correspond to a change of at least one of a type, a position, a state, or the number of image elements constituting the first image, using any one of the plurality of image elements constituting the second image.

In a case where the first image includes a knowledge graph based on action information and activity information, the user input for modifying the first image may correspond to a change of the knowledge graph of the first image, using any one of the plurality of image elements constituting the second image. For example, the user input for modifying the first image may correspond to modification of the knowledge graph by changing at least one of a type, a position, a state, or the number of nodes of the knowledge graph of the first image, using any one of the plurality of image elements constituting the second image.

The user device 100 may change the text of the journal, based on the change of the first image (e.g., operation S1750). The user device 100 may change the text of the journal, according to a change in at least one of a type, a position, a state, or the number of the image elements constituting the first image. The user device 100 may change the text of the journal, according to a change in at least one of a type, a position, a state, or the number of nodes of the knowledge graph of the first image. The user device 100 may obtain a changed text of the journal using the journal generation model receiving an input of the first user data changed according to the change in the first image.

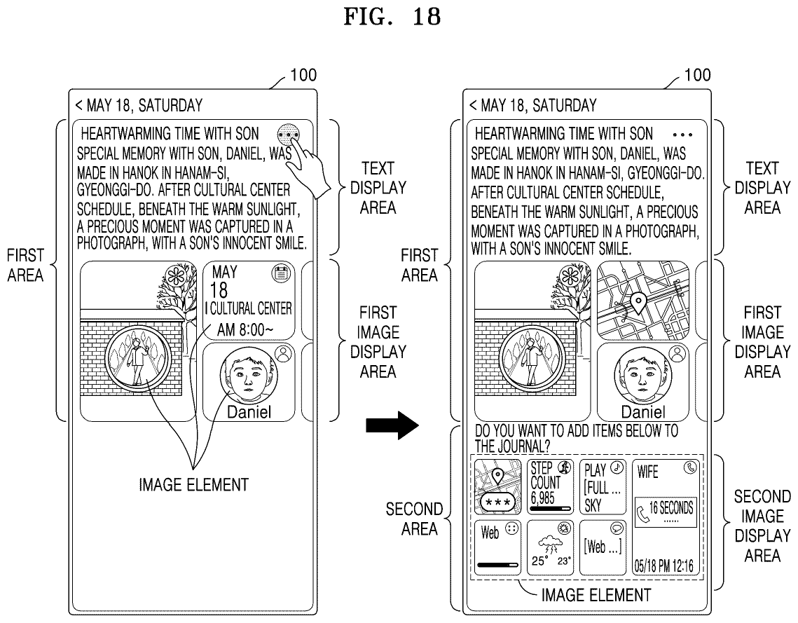

FIG. 18 is a diagram illustrating a second image for journal editing displayed in a second area of the display screen of the user device 100, according to an embodiment of the disclosure.

Referring to FIG. 18, a journal may be output to a first area of the display screen. The first area may correspond to one area of the display screen that is divided into a preset number of areas. The first area of the display screen is a journal area for providing a journal. The first area may be configured with a text display area and a first image display area. The text display area may output content of a journal with a title of the journal as a text on the top of the first area. The first image display area may output a first image based on the first user data used to generate the journal. The first user data may be configured with at least one user data, and the first image may be configured with at least one image element. Each image element may be an image, a picture, a graphical image, or the like.

The user device 100 may switch from the journal provision screen to a journal editing screen, according to a user input. For example, as shown in FIG. 18, a user may request the journal editing screen via a menu positioned at the right top of the first area. In response to the request for the journal editing screen from the user, the user device 100 may provide the journal editing screen.

The journal editing screen may be provided with the display screen divided into a first area and a second area. As shown in FIG. 18, the user device 100 may set a remaining area of the divided display screen, excluding the first area, as the second area. The first area and the second area may be positioned in a vertical relationship or a horizontal relationship, according to the division method with respect to the display screen.

The second area of the display screen may display the second image based on the second user data which is usable to change the text of the journal. The second area of the display screen may correspond to a portion of the remaining area of the entire display screen excluding the first area. The second area of the display screen may be an area with a predefined size or an area with a variable size that may vary according to a size of the first area. The second area may include a second image display area. The second image display area may output the second image based on the second user data which is usable to change the text of the journal. The second user data may include at least one user data, and the second image may be configured with at least one image element. As shown in FIG. 18, the second image may include a plurality of image elements, and each image element may be an image, a picture, a graphical image, or the like. Each image element may be displayed in a different size according to a degree to which user data corresponding to each image element is related to content of a journal. An image element with a higher likelihood of being used for editing the journal may be displayed in a larger size.

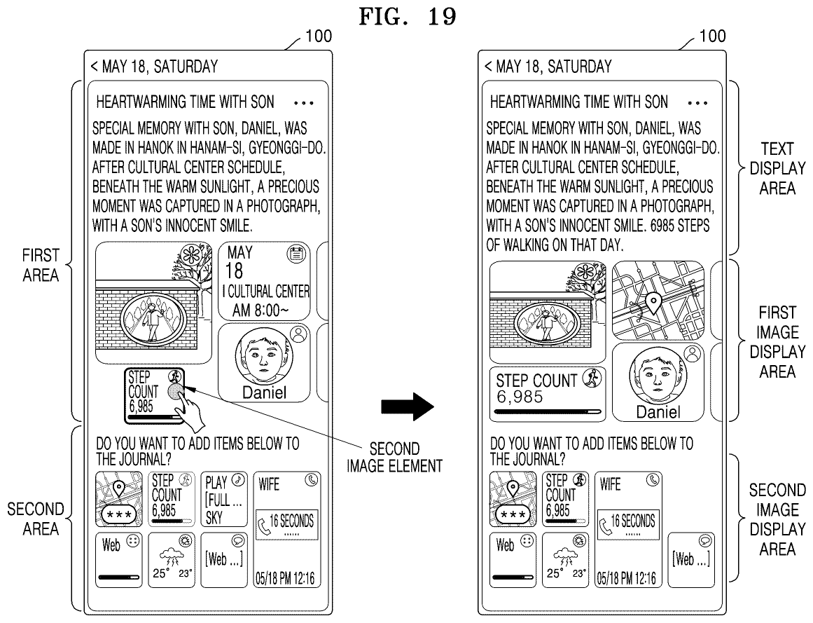

FIG. 19 is a diagram illustrating the user device 100 that edits a journal using a second image, according to an embodiment of the disclosure.

Referring to FIG. 19, a first image displayed in a first area may include at least one image element based on first user data used to generate the journal, and a second image displayed in a second area may include at least one image element based on second user data that is usable to modify a text of the journal.

The user device 100 may obtain a user input of moving, to the first area, a second image element from among image elements constituting the second image displayed in the second area. In response to the user input of moving, to the first area, the second image element from among image elements constituting the second image, the user device 100 may adjust positions of the image elements constituting the first image, according to a position of the second image element. Referring to FIG. 19, it is possible to identify that, when the second image element identified as “6,985 steps” is moved from the second area to the first area, an image element corresponding to a picture in a moving direction of the second image element is gradually reduced in size.

The user device 100 may obtain a user input of moving the second image element into the first area such that the second image element becomes an image element of the first image. Referring to FIG. 19, the user may drag and drop the second image element to a preset position in the first area. As a result, the second image element disappears from the second area, and the image element identified as “6,985 steps” is positioned along with existing image elements of the first image in the first area.

The user device 100 may change the text of the journal, based on the first image being modified according to movement of the second image element. As the second image element becomes the image element of the first image, at least one of a type, a position, a state, or the number of image elements constituting the first image is changed so that the first image is modified. The user device 100 may change the text of the journal, based on the first image being modified according to the position of the dragged and dropped second image element. The user device 100 may obtain a changed text of the journal using the journal generation model receiving an input of user data changed according to the change in the first image. Referring to FIG. 19, it is possible to identify that the text “I walked 6,985 steps that day” has been added in the content of the journal in a text display area.

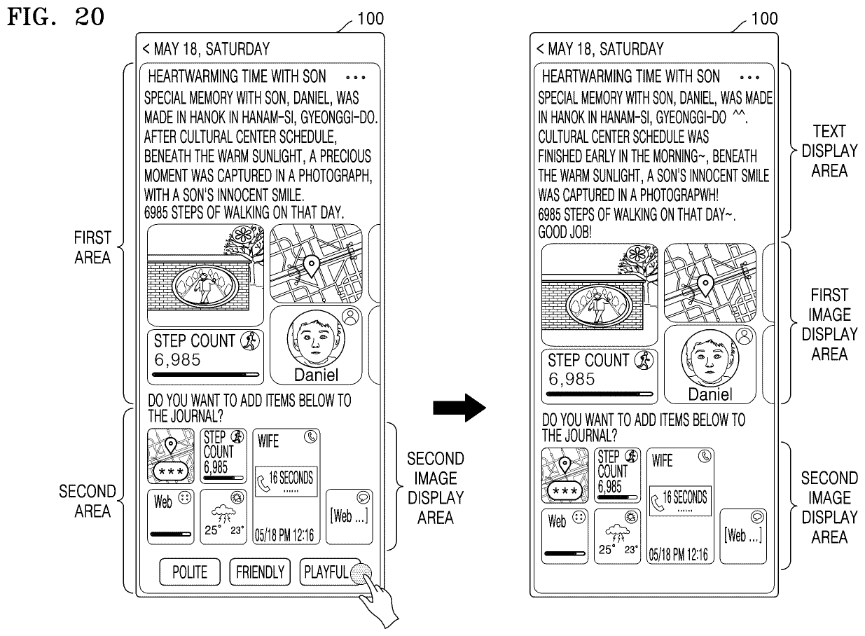

FIG. 20 is a diagram illustrating the user device 100 that selects a tone to be applied to a journal and edits the journal, according to an embodiment of the disclosure.

Referring to FIG. 20, the user device 100 may display a plurality of tone mode buttons for changing a tone of a text of the journal in a second area of the display screen. For example, as shown in FIG. 20, the tone mode buttons such as “Polite,” “Friendly,” and “Playful” may be provided in the second area, but types of the tone mode button are not limited thereto, and positions of the tone mode buttons are not limited thereto.

The user device 100 may obtain a user input of selecting a first tone mode button from among the plurality of tone mode buttons. For example, the user device 100 may obtain a user input of selecting the “Playful” tone mode button from among the plurality of tone mode buttons.

The user device 100 may change a text of the journal, according to a tone corresponding to the selected first tone mode button. The user device 100 may obtain a text of the journal according to the user-selected tone, via the journal generation model. The journal generation model that is the LLM may generate the journal based on textual information obtained from a personal knowledge graph and the user-requested tone mode. For example, as shown in FIG. 20, the user device 100 may, based on the “Playful” tone mode button selected by the user, add information regarding the tone mode to the LLM and may display the modified text of the journal changed from the existing text of the journal.

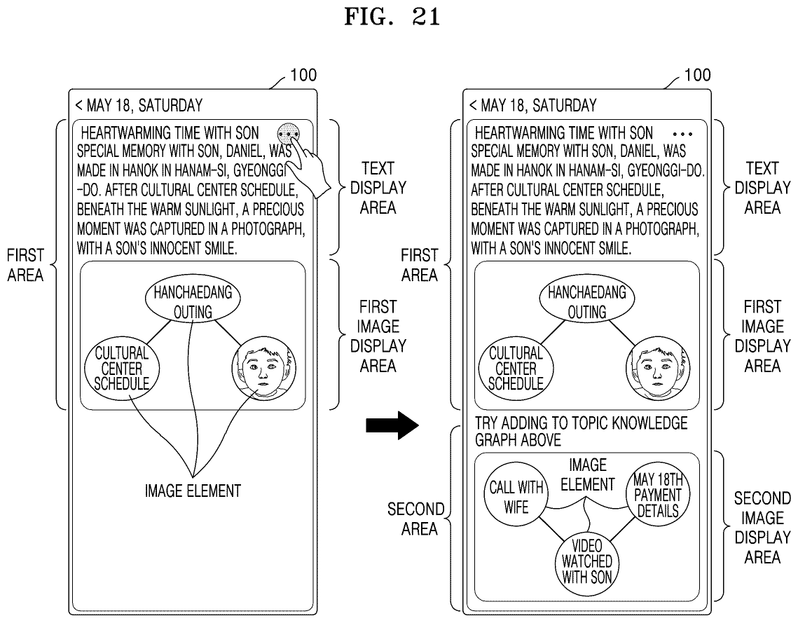

FIG. 21 is a diagram illustrating a second image for journal editing displayed in a second area of the display screen of the user device 100, according to an embodiment of the disclosure.

Referring to FIG. 21, a journal may be output to a first area of the display screen. The first area may be configured with a text display area and a first image display area. The text display area may output content of a journal with a title of the journal as a text on the top of the first area. The first image display area may output a first image based on the first user data used to generate the journal. The first user data may include at least one user data, and may be action information or activity information obtained from a personal knowledge graph. The first image may include a knowledge graph based on the action information or the activity information. Each node of the knowledge graph may be represented as an image element such as an image, a picture, a graphical image, etc., based on the action information or the activity information.

The user device 100 may switch from the journal provision screen to a journal editing screen, according to a user input. For example, as shown in FIG. 21, a user may request the journal editing screen via a menu positioned at the right top of the first area. In response to the request for the journal editing screen from the user, the user device 100 may provide the journal editing screen.

As shown in FIG. 21, the user device 100 may set a remaining area of the divided display screen, excluding the first area, as the second area and may display a second image based on second user data which is usable to modify the text of the journal. The second area of the display screen may correspond to a portion of the remaining area of the entire display screen excluding the first area. The second area of the display screen may be an area with a predefined size or an area with a variable size that may vary according to a size of the first area. The second area may include a second image display area. The second image display area may output the second image based on the second user data which is usable to change the text of the journal. The second user data may include at least one user data, and may be action information or activity information obtained from the personal knowledge graph. The second image may include an image element that corresponds to the action information or the activity information based on the second user data which is usable to add or modify the text of the journal. Each image element may be an image, a picture, a graphical image, or the like, based on the action information or the activity information.

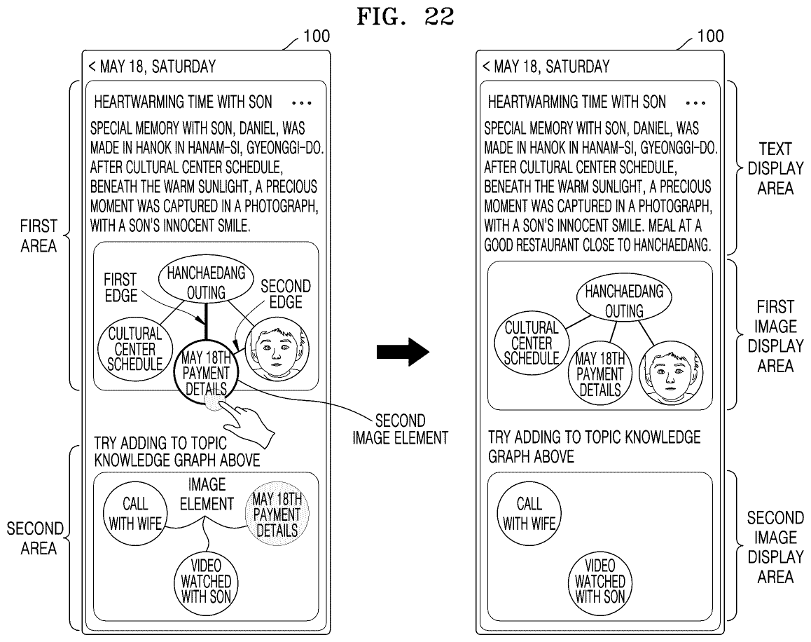

FIG. 22 is a diagram illustrating the user device 100 that edits a journal using a second image, according to an embodiment of the disclosure.

Referring to FIG. 22, a first image displayed in a first area may include a knowledge graph based on action information and activity information based on first user data used to generate the journal, and a second image may include an image element corresponding to action information or activity information based on second user data which is usable to modify a text of the journal.

The user device 100 may obtain a user input of moving a second image element into the first area such that the second image element becomes an image element of the first image, the second image element being from among image elements constituting the second image displayed in the second area. In response to the user input of moving, into the first area, the second image element from among the image elements constituting the second image, the user device 100 may display an edge between the second image element and at least one node of the knowledge graph based on a co-relationship between the second image element and nodes of the knowledge graph of the first image. As shown in FIG. 22, it is possible to identify that, when the user moves the second image element identified as ‘Payment Details for May 18’ from the second area to the first area, a first edge is formed between the second image element and a node identified as ‘Hanchaedang Outing’ in the knowledge graph of the first image, and a second edge is formed between the second image element and a node identified as ‘Son's Picture’ in the knowledge graph of the first image. In this regard, as a co-relationship between user data corresponding to the second image element and user data corresponding to the node identified as ‘Hanchaedang Outing’ in the knowledge graph of the first image is higher than a co-relationship between user data corresponding to the second image element and user data corresponding to the node identified as ‘Son's Picture’, the first edge may be displayed with a thicker or darker color line than the second edge. A co-relationship between the user data corresponding to the second image element and user data corresponding to a node identified as ‘Cultural Center Schedule’ in the knowledge graph of the first image does not satisfy a preset condition, and thus, an edge may not be formed between the node identified as ‘Cultural Center Schedule’ and the second image element in the knowledge graph of the first image.

The user device 100 may obtain the user input of moving the second image element into the first area such that the second image element becomes a node of the knowledge graph of the first image. Referring to FIG. 22, the user may drag and drop the second image element to a position where an edge is formed, so as to connect the second image element to the node identified as ‘Hanchaedang Outing’ in the knowledge graph of the first image. As a result, it is possible to identify that the second image element disappears from the second area, and a node identified as ‘May 18th Payment Details’ is generated in the knowledge graph of the first image.

The user device 100 may change the text of the journal, based on modification of the knowledge graph of the first image according to movement of the second image element. As the second image element becomes the node of the knowledge graph of the first image, at least one of a type, a position, a state, or the number of nodes of the knowledge graph of the first image is changed such that the knowledge graph of the first image may be modified. The user device 100 may change the text of the journal, based on modification of the knowledge graph of the first image according to a position of the dragged and dropped second image element. The user device 100 may obtain a changed text of the journal, using the journal generation model receiving an input of user data changed according to modification of the knowledge graph of the first image. Referring to FIG. 22, it is possible to identify that a text “meal at a good restaurant close to Hanchaedang” is further added to the content of the journal of the text display area.

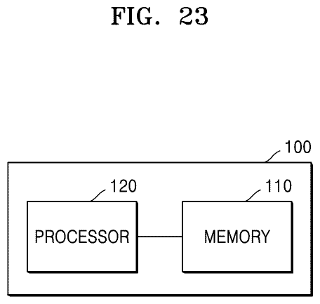

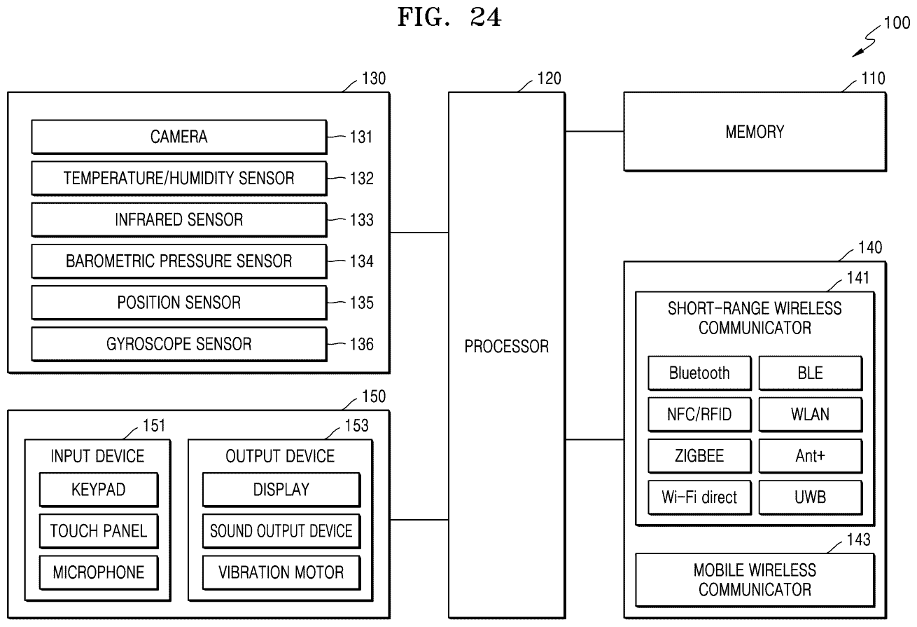

FIG. 23 is a block diagram illustrating the user device 100 according to an embodiment of the disclosure. FIG. 24 is a block diagram illustrating a configuration and operations of the user device 100 according to an embodiment of the disclosure.

Referring to FIG. 23, the user device 100 according to an embodiment of the disclosure may include memory 110 and a processor 120, but the disclosure is not limited thereto, and a general-purpose configuration may be further added. For example, as illustrated in FIG. 24, the user device 100 may further include a sensing unit 130, a communicator 140, and an input/output device 150, in addition to the memory 110 and the processor 120. Hereinafter, the respective components will now be described in detail with reference to FIGS. 23 and 24.

The memory 110 according to an embodiment of the disclosure may store a program for processing and control by the processor 120 and may store data and information input to or generated from the user device 100. The memory 110 may store instructions, a data structure, and program code which are readable by the processor 120. Operations performed by the processor 120 may be implemented by executing instructions or program codes stored in the memory 110.

The memory 110 according to an embodiment of the disclosure may include a flash memory-type memory, a hard disk-type memory, a multimedia card micro-type memory, or a card-type memory (e.g., secure digital (SD) or extreme digital (XD) memory), may include a non-volatile memory including at least one of a read-only memory (ROM), an electrically erasable programmable read-only memory (EEPROM), a programmable read-only memory (PROM), a magnetic memory, a magnetic disc, or an optical disc, and may include a volatile memory such as a random access memory (RAM) or a static random access memory (SRAM).

The memory 110 according to an embodiment of the disclosure may store one or more instructions and/or programs that control the user device 100 to train a neural network model or use a neural network model.

The processor 120 according to an embodiment of the disclosure may execute instructions or programmed software modules stored in the memory 110 so as to control operations or functions so that the user device 100 may perform tasks. The processor 120 may include hardware components that perform arithmetic, logic, and input/output calculations and signal processing. The processor 120 may execute one or more instructions stored in the memory 110 so as to control all operations of the user device 100. The processor 120 may execute programs stored in the memory 110 so as to control the sensing unit 130 including at least one sensor, the communicator 140, and the input/output device 150.

The processor 120 may include various processing circuitries and/or a plurality of processors. For example, the term “processor” as used herein, including the claims, may include various processing circuitries including at least one processor. “At least one processor” may be configured to individually and/or collectively perform various functions described herein. As used herein, the “processor,” “at least one processor,” and “one or more processors” may be configured to perform various functions. However, these terms may cover, without limitation, a situation where one processor performs some functions and other processor(s) perform other functions, and a situation where a single processor may perform all the functions. In addition, the “at least one processor” may include a combination of processors that perform the disclosed various functions in a distributed manner. The “at least one processor” may execute program instructions to accomplish or perform various functions.

The processor 120 according to an embodiment of the disclosure may include, for example, at least one of a CPU, a microprocessor, a GPU, application specific integrated circuits (ASICs), DSPs, digital signal processing devices (DSPDs), programmable logic devices (PLDs), field programmable gate arrays (FPGAs), an AP, an NPU, or a dedicated AI processor designed with a hardware structure specialized for processing an AI model, but the disclosure is not limited thereto. Each processor constituting the processor 120 may be a dedicated processor that performs a preset function.

The AI processor according to an embodiment of the disclosure may use an AI model to perform calculation and control to process a task set to be performed by the user device 100. The AI processor may be manufactured in the form of a dedicated hardware chip for AI, or may be manufactured as part of a general-purpose processor (e.g., a CPU or an AP) or a GPU and mounted on the user device 100.

The sensing unit 130 according to an embodiment of the disclosure may include a plurality of sensors configured to detect information about surrounding environment of the user device 100. For example, the sensing unit 130 may include a camera 131, a temperature/humidity sensor 132, an infrared sensor 133, a barometric pressure sensor 134, a position sensor 135, a gyroscope sensor 136, or the like, but the disclosure is not limited thereto. Because the functions of the sensors may be intuitively inferred from the names of the sensors by one of ordinary skill in the art, the functions of the sensors are briefly described below.

The camera 131 according to an embodiment of the disclosure may include a stereo camera, a mono camera, a wide-angle camera, an around-view camera, or a three-dimensional (3D) vision sensor. The temperature/humidity sensor 132 may measure a temperature or humidity of a position where the user device 100 is positioned. The infrared sensor 133 may be an active infrared sensor that detects a change by radiating infrared light and blocking the light, or a passive infrared sensor that does not have a light emitter and only detects a change in infrared light received from the outside. The barometric pressure sensor 134 may measure a barometric pressure at a position where the user device 100 is positioned. The position sensor 135 may detect a position of the user device 100. For example, the position sensor 135 may correspond to a global positioning system (GPS). The gyroscope sensor 136 may detect angular velocity. The gyroscope sensor 136 may be used to measure the position of the user device 100 and set the moving direction of the user device 100.

The communicator 140 may include one or more components that enable the user device 100 to communicate with an external device, for example, a server or other electronic devices. For example, the communicator 140 may include a short-range wireless communicator 141, a mobile wireless communicator 143, or the like, but the disclosure is not limited thereto.

The short-range wireless communicator 141 may include a Bluetooth communicator, a Bluetooth Low Energy (BLE) communicator, a Near Field Communication (NFC) communicator, a wireless local area network (WLAN) (Wi-Fi) communicator, a ZigBee communicator, an Ant+ communicator, a Wi-Fi Direction (WFD) communicator, an Ultra-Wideband (UWB) communicator, an Infrared Data Association (IrDA) communicator, a micro wave (uWave) communicator, or the like, but the disclosure is not limited thereto.

The mobile wireless communicator 143 may transmit and receive radio signals to and from at least one of a base station, an external terminal, or a server on a mobile communication network. The radio signals may include voice call signals, video call signals, or various types of data according to text/multimedia message transmission and reception.

The input/output device 150 may include an input device 151 and an output device 153. In the input/output device 150, the input device 151 and the output device 153 may be provided in a separate form, or may be provided in an integrated form such as a touch screen. The input/output device 150 may receive input information from the user, and may provide output information to the user.

The input device 151 may refer to a device for obtaining the user input for controlling the user device 100. For example, the input device 151 may include a key pad, a touch panel (a contact capacitance type touch panel, a pressure resistance film type touch panel, an infrared detection type touch panel, a surface ultrasonic conduction type touch panel, an integral tension measurement type touch panel, a piezo effect type touch panel, etc.), or a microphone, but the disclosure is not limited thereto. In addition, the input device 151 may include a gaze tracking sensor, a jog wheel, a jog switch, or the like, but the disclosure is not limited thereto. The user input may be in the form of a text, a voice, or a gesture, but the disclosure is not limited thereto. The user may input a search word or a sentence-form search command via a user interface or a microphone of the user device 100. The user may provide the user input to the user device 100 via a predefined gesture or behavior (e.g., an action of shaking the user device 100).

The output device 153 may output an audio signal, a video signal, or a vibration signal, and may include a display, a sound output device, and a vibration motor. The display may display information processed by the user device 100. For example, the display may display the user interface that receives a user's manipulation. When the display and a touch pad are configured as a touch screen having a layer structure, the display may be used as an input device as well as an output device. The display may include at least one of a liquid crystal display, a thin-film transistor-liquid crystal display, an organic light-emitting diode, a flexible display, or a 3D display. According to the implementation mode of the user device 100, the user device 100 may include two or more displays. The sound output device may output audio data stored in the memory 110. The sound output device may output sound signals related to the functions performed by the user device 100. The sound output interface may include a speaker, a buzzer, or the like.

The user device 100 according to an embodiment of the disclosure may include the memory 110 including one or more storage media storing one or more instructions, and the at least one processor 120 including processing circuitry. The at least one processor 120 may be configured to execute the one or more instructions to load and execute instructions or code for a preset module configured to generate a personal knowledge graph based on co-related user data.

According to an embodiment of the disclosure, the at least one processor 120 of the user device 100 may be configured to execute the one or more instructions to obtain a first data group clustered from user data related to a first application. The at least one processor 120 may be configured to obtain the first data group by clustering the user data related to the first application, based on information about a generation time point of the user data. The least one processor 120 may be configured to obtain the first data group by clustering the user data related to the first application, based on information about a particular place or information about a particular user. A reference with respect to clustering may vary depending on each application.

According to an embodiment of the disclosure, the at least one processor 120 may be configured to execute the one or more instructions to identify a first generation time period corresponding to the first data group, based on a generation time point of the user data included in the first data group. For example, the at least one processor 120 may be configured to execute the one or more instructions to identify a time period from a generation time point of user data that is first generated from among a plurality of pieces of user data included in the first data group to a generation time point of user data that is last generated. As another example, the at least one processor 120 may be configured to execute the one or more instructions to identify a time period from a generation time point of user data included in the first data group to a preset time point.

According to an embodiment of the disclosure, the at least one processor 120 may be configured to execute the one or more instructions to obtain at least one second data group that corresponds to the first generation time period corresponding to the first data group and is clustered from user data related to at least one second application different from the first application. The at least one processor 120 may be configured to extract user data that corresponds to the first generation time period corresponding to the first data group and is from among a plurality of pieces of user data related to the at least one second application. The at least one processor 120 may be configured to obtain the least one second data group by clustering the extracted user data, based on information about a generation time point.

According to an embodiment of the disclosure, the at least one processor 120 may be configured to execute the one or more instructions to determine whether a second generation time period corresponding to the least one second data group exceeds the first generation time period corresponding to the first data group. As a result of the determination, when the second generation time period corresponding to the least one second data group exceeds the first generation time period corresponding to the first data group, the at least one processor 120 may be configured to repeat a process of obtaining at least one second data group by extending the first generation time period, based on the second generation time period. As a result of the determination, when the second generation time period corresponding to the least one second data group does not exceed the first generation time period corresponding to the first data group, the at least one processor 120 may be configured to end a process of obtaining at least one second data group.

According to an embodiment of the disclosure, the at least one processor 120 may be configured to execute the one or more instructions to obtain a personal knowledge graph based on user data having a co-relationship from the first data group and the at least one second data group. The at least one processor 120 may be configured to generate the personal knowledge graph based on the first data group and the at least one second data group. The at least one processor 120 may be configured to determine a co-relationship between nodes in the generated personal knowledge graph. The at least one processor 120 may be configured to determine a co-relationship between nodes, based on at least one of whether a node connected to a first node based on the user data of the first data group exists, the number of nodes connected to the first node, whether a node connected to a second node connected to the first node exists, or the number of nodes connected to the second node connected to the first node. The at least one processor 120 may be configured to delete a node without a co-relationship from the personal knowledge graph, based on a preset reference.

According to an embodiment of the disclosure, the at least one processor 120 may be configured to execute the one or more instructions to determine whether the personal knowledge graph based on the user data having the co-relationship has distinctiveness according to a preset reference. The at least one processor 120 may be configured to generate sentences from user data of each node reflected to the personal knowledge graph, the sentences being to be input to a LLM or a machine-learning based model for determining distinctiveness of a personal knowledge graph. The user device 100 may determine whether the personal knowledge graph has distinctiveness by inputting the generated sentences to the LLM or the machine-learning based model for determining distinctiveness. According to a result of the determination, the at least one processor 120 may be configured to store the personal knowledge graph based on the user data having the co-relationship when there is distinctiveness of the personal knowledge graph and not to store the personal knowledge graph based on the user data having the co-relationship when there is no distinctiveness.

According to an embodiment of the disclosure, the at least one processor 120 may be configured to execute the one or more instructions to construct a personalized database by storing the personal knowledge graph based on the user data having the co-relationship in a preset space in the user device 100. The at least one processor 120 may be configured to execute the one or more instructions to provide a personal knowledge graph-based service by obtaining a personal knowledge graph or user data of the personal knowledge graph from the constructed personalized database.

According to an embodiment of the disclosure, the user device 100 may include the memory 110 including one or more storage media storing one or more instructions, the at least one processor 120 including processing circuitry, and the input/output device 150 for outputting a display screen. The at least one processor 120 may be configured to execute the one or more instructions to load and execute instructions or code for a module configured to provide a personal knowledge graph-based journal.

According to an embodiment of the disclosure, the at least one processor 120 of the user device 100 may be configured to execute the one or more instructions to generate a journal using a personal knowledge graph based on user data having a co-relationship. The at least one processor 120 may be configured to execute the one or more instructions to obtain a sentence-form text of the journal via a journal generation model using a personal knowledge graph based on user data having a co-relationship. The at least one processor 120 may be configured to execute the one or more instructions to obtain a text of a journal corresponding to first user data obtained from the personal knowledge graph and a first image based on the first user data.

According to an embodiment of the disclosure, the at least one processor 120 of the user device 100 may be configured to execute the one or more instructions to display the first image and the text of the journal in a first area of a display screen, the first image being based on the first user data used to generate the journal. The first user data may include a plurality of pieces of user data, and the first image may include a plurality of image elements corresponding to the plurality of pieces of user data. The first image may include an image element including a representative image such as a thumbnail, a preview, etc., a picture, a graphical image, or the like. For example, the first user data may be at least one activity information obtained from a personal knowledge graph based on activity information having a co-relationship. The first image may be represented as image elements including a representative image, a picture, a graphical image, etc., based on the at least one activity information. Alternatively, the first image may include a knowledge graph including the at least one activity information as a node. Each node of the knowledge graph may be represented as an image element including a representative image, a picture, a graphical image, etc., based on the activity information.

According to an embodiment of the disclosure, the at least one processor 120 of the user device 100 may be configured to execute the one or more instructions to obtain a user input for modifying the first image displayed in the first area. The user input may include a touch input, a voice, or a gesture of a user, but the disclosure is not limited thereto. The user may input a command related to modification of the first image, via a user interface or a microphone provided to the input/output device 150 of the user device 100. The user may give the user input to the user device 100, as a predefined gesture or action.

The at least one processor 120 may be configured to execute the one or more instructions to obtain a user input for modifying any one of a plurality of image elements constituting the first image. For example, the at least one processor 120 may be configured to obtain the user input for modifying the first image by changing at least one of a type, a position, a state, or the number of the image elements constituting the first image. For example, when the first image includes a knowledge graph based on action information corresponding to an operation of the user and activity information configured with a plurality of pieces of sequential action information, a user input for modifying the first image may correspond to modification of the knowledge graph by changing at least one of a type, a position, a state, or the number of nodes of the knowledge graph.

According to an embodiment of the disclosure, the at least one processor 120 of the user device 100 may be configured to execute the one or more instructions to change the text of the journal, based on the modification of the first image displayed in the first area of the display screen. The at least one processor 120 of the user device 100 may be configured to change the text of the journal, based on a change in at least one of a type, a position, a state, or the number of the image elements constituting the first image. The at least one processor 120 may be configured to execute the one or more instructions to change the first user data used to generate the journal in the personal knowledge graph according to a change in the first image, or change an existing personal knowledge graph. The at least one processor 120 may be configured to execute the one or more instructions to obtain the changed text of the journal, using the journal generation model receiving an input of the first user data changed according to the change in the first image.

According to an embodiment of the disclosure, the at least one processor 120 of the user device 100 may be configured to execute the one or more instructions to obtain a user input of selecting a first image element from among the image elements constituting the first image, and change the text of the journal such that a text corresponding to the first image element may be identified from the text of the journal. According to an embodiment of the disclosure, the at least one processor 120 may be configured to execute the one or more instructions to obtain a user input of deleting the first image element from among the image elements constituting the first image, and change the text of the journal such that the text corresponding to the first image element is deleted from the text of the journal.

When the first image includes a knowledge graph based on action information and activity information, the at least one processor 120 according to an embodiment of the disclosure may be configured to execute the one or more instructions to obtain a user input of moving, in the first area, a position of a first node of the knowledge graph, and change the text of the journal, based on the knowledge graph being modified according to a changed position of the first node. According to an embodiment of the disclosure, the at least one processor 120 may be configured to execute the one or more instructions to obtain a user input for modifying user data related to a first node of a knowledge graph, and change a text of a journal, based on a change in the knowledge graph according to the modified user data.

According to an embodiment of the disclosure, the at least one processor 120 of the user device 100 may be configured to execute the one or more instructions to display, in a second area of the display screen, a second image based on second user data usable to change a text of the journal. The at least one processor 120 may be configured to obtain the second user data from the personal knowledge graph. The second user data may be user data that is related to the first user data but was not used to generate the journal. The second user data may be user data related to a text that is addible to the journal. The second user data may be candidate user data that is usable to add or modify a text of the journal. The second user data may be remaining user data excluding the first user data extracted from the personal knowledge graph. The second user data may include a plurality of pieces of user data. For example, the second user data may be at least one activity information obtained from the personal knowledge graph based on activity information having a co-relationship, and may be candidate activity information usable to change in a text of the journal. The second image may include a plurality of image elements corresponding to the plurality of pieces of user data. The second image may include an image element including a representative image such as a thumbnail, a preview, etc., a picture, a graphical image, or the like. The second image may be represented as image elements including a representative image, a picture, a graphical image, etc., based on at least one candidate activity information. Alternatively, the second image may be represented as image elements corresponding to action information or activity information based on the second user data, and may be an image, a picture, a graphical image, etc., based on the action information or the activity information.

According to an embodiment of the disclosure, the at least one processor 120 of the user device 100 may be configured to execute the one or more instructions to obtain a user input for modifying the first image using the second image. The at least one processor 120 may be configured to obtain the user input for modifying the first image using any one of the plurality of image elements constituting the second image. The at least one processor 120 may be configured to obtain a user input of moving, to the first area, a second image element from among the image elements constituting the second image. For example, the at least one processor 120 may be configured to obtain the user input for modifying the first image by changing at least one of a type, a position, a state, or the number of the image elements constituting the first image, using any one of the plurality of image elements constituting the second image. The at least one processor 120 may be configured to execute the one or more instructions to change a text of the journal, based on that the first image is modified according to movement of the second image element. The at least one processor 120 may be configured to change a text of the journal, according to a change in at least one of a type, a position, a state, or the number of the image elements constituting the first image.

According to an embodiment of the disclosure, when the first image includes the knowledge graph based on the action information and the activity information used to generate the journal, and the second image includes an image element corresponding to the action information or the activity information based on the second user data usable to change a text of the journal, the at least one processor 120 of the user device 100 may be configured to execute the one or more instructions to obtain the user input for modifying the knowledge graph of the first image using any one image element from among the plurality of image elements constituting the second image. For example, the at least one processor 120 may be configured to obtain a user input of moving, to the first area, the second image element from among the image elements constituting the second image. In response to the user input of moving the second image element to the first area, the at least one processor 120 may be configured to display an edge between the second image element and at least one node of the knowledge graph, the edge being based on a co-relationship between the second image element and nodes of the knowledge graph of the first image. The at least one processor 120 may be configured to obtain a user input of moving the second image element into the first area such that the second image element is a node of the knowledge graph of the first image. The at least one processor 120 may be configured to change a text of the journal, based on a change in the knowledge graph of the first image according to movement of the second image element. The at least one processor 120 may be configured to change a text of the journal according to a change in at least one of a type, a position, a state, or the number of nodes of the knowledge graph of the first image. The at least one processor 120 may be configured to obtain the changed text of the journal using a journal generation model receiving an input of the first user data changed according to the change in the first image.

An embodiment of the disclosure may be implemented in the form of a recording medium including computer-executable instructions such as program modules executable by a computer. A computer-readable recording medium may be any available media that are accessible by the computer and may include any volatile and non-volatile media and any removable and non-removable media. In addition, the computer-readable recording medium may include a computer storage medium and a communication medium. The computer storage medium may include any volatile, non-volatile, removable, and non-removable media that are implemented in any method or technology for storage of information such as computer-readable instructions, data structures, program modules, or other data. The communication medium may typically include computer-readable instructions, data structures, or other data of a modulated data signal, such as program modules.

Also, the computer-readable recording medium may be provided in the form of a non-transitory computer-readable recording medium. The ‘non-transitory storage medium’ is a tangible device and only means not including a signal (e.g., electromagnetic waves). This term does not distinguish between a case where data is semi-permanently stored in a storage medium and a case where data is temporarily stored in a storage medium. For example, the ‘non-transitory storage medium’ may include a buffer in which data is temporarily stored.

The method according to an embodiment of the disclosure may be provided by being included in a computer program product. The computer program product may be traded between a seller and a buyer as commodities. The computer program product may be distributed in the form of a machine-readable storage medium (e.g., compact disc read-only memory (CD-ROM)), or may be distributed (e.g., downloaded or uploaded) online either via an application store or directly between two user devices (e.g., smartphones). In the case of the online distribution, at least a part of a computer program product (e.g., downloadable app) is stored at least temporarily on a machine-readable storage medium, such as a server of a manufacturer, a server of an application store, or memory of a relay server, or may be temporarily generated.

According to an embodiment of the disclosure, a computer-readable recording medium having recorded thereon a program for executing a method of generating a personal knowledge graph or a method of providing a personal knowledge graph-based journal, the method being performed by the user device, is provided.

According to an embodiment of the disclosure, a method of generating a personal knowledge graph is provided. The method of generating a personal knowledge graph may include obtaining a first data group clustered from user data related to a first application (e.g., operation S410). Also, the method of generating a personal knowledge graph may include identifying a generation time period corresponding to the first data group, based on generation time points of a plurality of pieces of user data included in the first data group (e.g., operation S420). Also, the method of generating a personal knowledge graph may include obtaining at least one second data group corresponding to a first generation time period and clustered from user data related to at least one second application different from the first application (e.g., operation S430). Also, the method of generating a personal knowledge graph may include obtaining a personal knowledge graph based on user data having a co-relationship, from the first data group and the at least one second data group (e.g., operation S440).

Also, according to an embodiment of the disclosure, the obtaining of the first data group (e.g., operation S410) may include obtaining the first data group by clustering the user data related to the first application, based on information about a generation time point of the user data.

Also, according to an embodiment of the disclosure, the identifying of the generation time period corresponding to the first data group (e.g., operation S420) may include identifying a time period from a generation time point of user data that is first generated from among a plurality of pieces of user data included in the first data group to a generation time point of user data that is last generated.

Also, according to an embodiment of the disclosure, the identifying of the generation time period corresponding to the first data group (e.g., operation S420) may include identifying a time period from a generation time point of user data included in the first data group to a preset time point.

Also, according to an embodiment of the disclosure, the obtaining of the at least one second data group (e.g., operation S430) may include extracting user data that corresponds to the first generation time period corresponding to the first data group and is from among a plurality of pieces of user data related to the at least one second application. Also, the obtaining of the at least one second data group (e.g., operation S430) may include obtaining the least one second data group by clustering the extracted user data, based on information about a generation time point (e.g., operation S620).

Also, the obtaining of the at least one second data group (e.g., operation S430) may include determining whether a second generation time period corresponding to the least one second data group exceeds the first generation time period corresponding to the first data group (e.g., operation S630). According to a result of determining whether the second generation time period exceeds the first generation time period, the obtaining of the at least one second data group (e.g., operation S430) may include, when the second generation time period exceeds the first generation time period, repeating a process of obtaining at least one second data group by extending the first generation time period, based on the second generation time period, and may include, when the second generation time period does not exceed the first generation time period, ending a process of obtaining at least one second data group (e.g., operation S640).

Also, according to an embodiment of the disclosure, the obtaining of the personal knowledge graph (e.g., operation S440) may include generating the personal knowledge graph based on the first data group and the at least one second data group (e.g., operation S810). Also, the obtaining of the personal knowledge graph (e.g., operation S440) may include determining a co-relationship between nodes in the generated personal knowledge graph (e.g., operation S820). Also, the obtaining of the personal knowledge graph (e.g., operation S440) may include deleting a node without a co-relationship from the personal knowledge graph, based on a preset reference (e.g., operation S830).

Also, the determining of the co-relationship between the nodes (e.g., operation S820) may include determining the co-relationship between the nodes, based on at least one of whether a node connected to a first node based on the user data of the first data group exists, the number of nodes connected to the first node, whether a node connected to a second node connected to the first node exists, or the number of nodes connected to the second node.

Also, according to an embodiment of the disclosure, the obtaining of the personal knowledge graph (e.g., operation S440) may include determining whether the personal knowledge graph based on the user data having the co-relationship has distinctiveness according to a preset reference. Also, according to a result of determining whether there is distinctiveness, the obtaining of the personal knowledge graph (e.g., operation S440) may include storing the personal knowledge graph based on the user data having the co-relationship when there is distinctiveness and may include not storing the personal knowledge graph based on the user data having the co-relationship when there is no distinctiveness (e.g., operation S850).

According to an embodiment of the disclosure, a non-transitory, computer-readable recording medium having recorded thereon a program for executing the aforementioned method of generating a personal knowledge graph is provided.

According to an embodiment of the disclosure, the user device 100 for generating a personal knowledge graph is provided. The user device 100 may include the memory 110 including one or more storage media storing one or more instructions and the at least one processor 120 including processing circuitry. The one or more instructions, when executed by the at least one processor 120, may cause the user device 100 to obtain a first data group clustered from user data related to a first application. Also, the one or more instructions, when executed by the at least one processor 120, may cause the user device 100 to identify a first generation time period corresponding to the first data group, based on a generation time point of the user data included in the first data group. Also, the one or more instructions, when executed by the at least one processor 120, may cause the user device 100 to obtain at least one second data group that corresponds to the first generation time period corresponding to the first data group and is clustered from user data related to at least one second application different from the first application. Also, the one or more instructions, when executed by the at least one processor 120, may cause the user device 100 to obtain a personal knowledge graph based on user data having a co-relationship from the first data group and the at least one second data group.

Also, according to an embodiment of the disclosure, the one or more instructions, when executed by the at least one processor 120, may cause the user device 100 to obtain the first data group by clustering the user data related to the first application, based on information about a generation time point of the user data.

Also, according to an embodiment of the disclosure, the one or more instructions, when executed by the at least one processor 120, may cause the user device 100 to identify the first generation time period corresponding to the first data group by identifying a time period from a generation time point of user data that is first generated from among a plurality of pieces of user data included in the first data group to a generation time point of user data that is last generated.

Also, according to an embodiment of the disclosure, the one or more instructions, when executed by the at least one processor 120, may cause the user device 100 to identify the first generation time period corresponding to the first data group by identifying a time period from a generation time point of user data included in the first data group to a preset time point.

Also, according to an embodiment of the disclosure, the one or more instructions, when executed by the at least one processor 120, may cause the user device 100 to extract user data that corresponds to the first generation time period corresponding to the first data group and is from among a plurality of pieces of user data related to the at least one second application. Also, the one or more instructions, when executed by the at least one processor 120, may cause the user device 100 to obtain the least one second data group by clustering the extracted user data, based on information about a generation time point.

Also, the one or more instructions, when executed by the at least one processor 120, may cause the user device 100 to determine whether a second generation time period corresponding to the least one second data group exceeds the first generation time period corresponding to the first data group. Also, according to a result of determining whether the second generation time period exceeds the first generation time period, the one or more instructions, when executed by the at least one processor 120, may cause the user device 100 to, when the second generation time period exceeds the first generation time period, repeat a process of obtaining at least one second data group by extending the first generation time period, based on the second generation time period, and, when the second generation time period does not exceed the first generation time period, end a process of obtaining at least one second data group.

Also, according to an embodiment of the disclosure, the one or more instructions, when executed by the at least one processor 120, may cause the user device 100 to generate the personal knowledge graph based on the first data group and the at least one second data group, determine a co-relationship between nodes in the generated personal knowledge graph, and delete a node without the co-relationship from the personal knowledge graph, based on a preset reference.

Also, the one or more instructions, when executed by the at least one processor 120, may cause the user device 100 to determine a co-relationship between nodes, based on at least one of whether a node connected to a first node based on the user data of the first data group exists, the number of nodes connected to the first node, whether a node connected to a second node connected to the first node exists, or the number of nodes connected to the second node.

Also, according to an embodiment of the disclosure, the one or more instructions, when executed by the at least one processor 120, may cause the user device 100 to determine whether the personal knowledge graph has distinctiveness according to a preset reference. Also, according to a result of determining whether there is distinctiveness, the one or more instructions, when executed by the at least one processor 120, may cause the user device 100 to store the personal knowledge graph based on the user data having the co-relationship when there is distinctiveness and not to store the personal knowledge graph based on the user data having the co-relationship when there is no distinctiveness.

Also, according to an embodiment of the disclosure, the one or more instructions, when executed by the at least one processor 120, may cause the user device 100 to generate sentences from user data of each node reflected to the personal knowledge graph. Also, the one or more instructions, when executed by the at least one processor 120, may cause the user device 100 to determine whether there is distinctiveness according to a preset reference, by inputting the generated sentences to the LLM or the machine-learning based model.

According to an embodiment of the disclosure, a method of providing a personal knowledge graph-based journal is provided. The method of providing a personal knowledge graph-based journal may include generating a journal using a personal knowledge graph based on user data having a co-relationship (e.g., operations S1110, S1710). The method of providing a personal knowledge graph-based journal may include displaying a first image and a text of the journal in a first area of a display screen, the first image being based on first user data used to generate the journal (e.g., operations S1120, S1720). The method of providing a personal knowledge graph-based journal may include obtaining a user input for modifying the first image displayed in the first area (e.g., operation S1130). The method of providing a personal knowledge graph-based journal may include changing the text of the journal, based on the first image being modified (e.g., operations S1140, S1750).

According to an embodiment of the disclosure, the obtaining of the user input (e.g., operation S1130) may include obtaining the user input for modifying the first image by changing at least one of a type, a position, a state, or the number of image elements constituting the first image.

According to an embodiment of the disclosure, the obtaining of the user input (e.g., operation S1130) may include obtaining a user input of selecting a first image element from among image elements constituting the first image. Also, the changing of the text of the journal (e.g., operation S1140) may include changing the text of the journal such that a text corresponding to the first image element is identified from the text of the journal.

According to an embodiment of the disclosure, the obtaining of the user input (e.g., operation S1130) may include obtaining a user input of deleting a first image element from among image elements constituting the first image. Also, the changing of the text of the journal (e.g., operation S1140) may include changing the text of the journal such that a text corresponding to the first image element is deleted from the text of the journal.

According to an embodiment of the disclosure, when the first image includes a knowledge graph based on action information corresponding to an operation of a user and activity information configured with a plurality of pieces of sequential action information, the obtaining of the user input (e.g., operation S1130) may include obtaining a user input of moving, in the first area, a position of a first node of the knowledge graph. Also, the changing of the text of the journal (e.g., operation S1140) may include changing the text of the journal, based on the knowledge graph being modified according to a changed position of the first node.

According to an embodiment of the disclosure, when the first image includes a knowledge graph based on action information corresponding to an operation of a user and activity information configured with a plurality of pieces of sequential action information, the obtaining of the user input (e.g., operation S1130) may include obtaining a user input for modifying user data related to a first node of the knowledge graph. Also, the changing of the text of the journal (e.g., operation S1140) may include changing the text of the journal, based on the knowledge graph being modified according to the modified user data.

According to an embodiment of the disclosure, the method of providing a personal knowledge graph-based journal may further include displaying, in a second area of the display screen, a second image based on second user data usable to change the text of the journal (e.g., operation S1730). The obtaining of the user input (e.g., operation S1130) may include obtaining the user input for modifying the first image using the second image (e.g., operation S1740).

According to an embodiment of the disclosure, the obtaining of the user input (e.g., operation S1740) may include obtaining a user input of moving, to the first area, a second image element from among image elements constituting the second image. Also, the changing of the text of the journal (e.g., operation S1750) may include changing the text of the journal, based on the first image being modified according to moving of the second image element.

According to an embodiment of the disclosure, when the first image includes a knowledge graph based on action information corresponding to an operation of a user and activity information configured with a plurality of pieces of sequential action information, and the second image includes an image element corresponding to action information or activity information based on the second user data, the obtaining of the user input (e.g., operation S1740) may include displaying an edge between a second image element and at least one node of the knowledge graph, the edge being based on a co-relationship between the second image element and nodes of the knowledge graph of the first image, in response to a user input of moving, to the first area, the second image element from among image elements constituting the second image. Also, the obtaining of the user input (e.g., operation S1740) may include obtaining a user input of moving the second image element into the first area such that the second image element is a node of the knowledge graph. Also, the changing of the text of the journal (e.g., operation S1750) may include changing the text of the journal, based on the knowledge graph being modified according to moving of the second image element.

According to an embodiment of the disclosure, a computer-readable recording medium having recorded thereon a program for executing the aforementioned method of providing a personal knowledge graph-based journal is provided.

According to an embodiment of the disclosure, the user device 100 for providing a personal knowledge graph-based journal is provided. The user device 100 may include the memory 110 including one or more storage media storing one or more instructions, the at least one processor 120 including processing circuitry, and the input/output device 150 configured to output a display screen. The one or more instructions, when executed by the at least one processor 120, may cause the user device 100 to generate a journal using a personal knowledge graph based on user data having a co-relationship. Also, the one or more instructions, when executed by the at least one processor 120, may cause the user device 100 to display a first image and a text of the journal in a first area of the display screen, the first image being based on first user data used to generate the journal. Also, the one or more instructions, when executed by the at least one processor 120, may cause the user device 100 to obtain a user input for modifying the first image displayed in the first area. Also, the one or more instructions, when executed by the at least one processor 120, may cause the user device 100 to change the text of the journal, based on the first image being modified.

According to an embodiment of the disclosure, the one or more instructions, when executed by the at least one processor 120, may cause the user device 100 to obtain the user input for modifying the first image by changing at least one of a type, a position, a state, or the number of image elements constituting the first image.

According to an embodiment of the disclosure, the one or more instructions, when executed by the at least one processor 120, may cause the user device 100 to obtain a user input of selecting a first image element from among image elements constituting the first image. Also, the one or more instructions, when executed by the at least one processor 120, may cause the user device 100 to change the text of the journal such that a text corresponding to the first image element is identified from the text of the journal.

According to an embodiment of the disclosure, the one or more instructions, when executed by the at least one processor 120, may cause the user device 100 to obtain a user input of deleting a first image element from among image elements constituting the first image. Also, the one or more instructions, when executed by the at least one processor 120, may cause the user device 100 to change the text of the journal such that a text corresponding to the first image element is deleted from the text of the journal.

According to an embodiment of the disclosure, when the first image includes a knowledge graph based on action information corresponding to an operation of a user and activity information configured with a plurality of pieces of sequential action information, the one or more instructions, when executed by the at least one processor 120, may cause the user device 100 to obtain a user input of moving, in the first area, a position of a first node of the knowledge graph. Also, the one or more instructions, when executed by the at least one processor 120, may cause the user device 100 to change the text of the journal, based on the knowledge graph being modified according to a changed position of the first node.

According to an embodiment of the disclosure, when the first image includes a knowledge graph based on action information corresponding to an operation of a user and activity information configured with a plurality of pieces of sequential action information, the one or more instructions, when executed by the at least one processor 120, may cause the user device 100 to obtain a user input for modifying user data related to a first node of the knowledge graph. Also, the one or more instructions, when executed by the at least one processor 120, may cause the user device 100 to change the text of the journal, based on the knowledge graph being modified according to the modified user data.

According to an embodiment of the disclosure, the one or more instructions, when executed by the at least one processor 120, may cause the user device 100 to display, in a second area of the display screen, a second image based on second user data usable to change the text of the journal. Also, the one or more instructions, when executed by the at least one processor 120, may cause the user device 100 to obtain the user input for modifying the first image using the second image.

According to an embodiment of the disclosure, the one or more instructions, when executed by the at least one processor 120, may cause the user device 100 to obtain a user input of moving, to the first area, a second image element from among image elements constituting the second image. Also, the one or more instructions, when executed by the at least one processor 120, may cause the user device 100 to change the text of the journal, based on the first image being modified according to moving of the second image element.

According to an embodiment of the disclosure, when the first image includes a knowledge graph based on action information corresponding to an operation of a user and activity information configured with a plurality of pieces of sequential action information, and the second image includes an image element corresponding to action information or activity information based on the second user data, the one or more instructions, when executed by the at least one processor 120, may cause the user device 100 to display an edge between a second image element and at least one node of the knowledge graph, the edge being based on a co-relationship between the second image element and nodes of the knowledge graph of the first image, in response to a user input of moving, to the first area, the second image element from among image elements constituting the second image, and obtain a user input of moving the second image element into the first area such that the second image element is a node of the knowledge graph. Also, the one or more instructions, when executed by the at least one processor 120, may cause the user device 100 to change the text of the journal, based on the knowledge graph being modified according to moving of the second image element.

According to an embodiment of the disclosure, the one or more instructions, when executed by the at least one processor 120, may cause the user device 100 to display, in the second area of the display screen, a plurality of tone mode buttons for changing a tone of the text of the journal, and obtain a user input of selecting a first tone mode button. Also, the one or more instructions, when executed by the at least one processor 120, may cause the user device 100 to change the text of the journal, based on a tone corresponding to the selected first tone mode button.

At least one of the devices, units, components, modules, units, or the like represented by a block or an equivalent indication in the above embodiments may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

Each of the embodiments provided in the above description is not excluded from being associated with one or more features of another example or another embodiment also provided herein or not provided herein but consistent with the disclosure.

The embodiments of the disclosure disclosed in the specification and the drawings provide merely specific examples to easily describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A method of providing a personal knowledge graph-based journal, the method comprising:
generating a journal using a personal knowledge graph based on user data having a co-relationship;
displaying a first image and a text of the journal in a first area of a display screen, the first image being generated based on first user data used to generate the journal;
obtaining a user input for modifying the first image displayed in the first area; and
changing the text of the journal based on the first image being modified.

2. The method of claim 1, further comprising modifying the first image based on the user input by changing at least one of a type, a position, a state, or a number of image elements constituting the first image.

3. The method of claim 1, wherein the obtaining of the user input comprises obtaining a user input selecting a first image element from among image elements constituting the first image, and
wherein the changing of the text of the journal comprises changing the text of the journal such that a text corresponding to the first image element is identifiable from the text of the journal.

4. The method of claim 1, wherein the obtaining of the user input comprises obtaining a user input for deleting a first image element from among image elements constituting the first image, and
wherein the changing of the text of the journal comprises changing the text of the journal such that a text corresponding to the first image element is deleted from the text of the journal.

5. The method of claim 1, wherein, based on the first image comprising a knowledge graph based on action information corresponding to an operation of a user and activity information configured with a plurality of pieces of sequential action information:
the obtaining of the user input comprises obtaining a user input moving, in the first area, a position of a first node of the knowledge graph, and
the changing of the text of the journal comprises changing the text of the journal, based on the knowledge graph being modified according to a moved position of the first node.

6. The method of claim 1, wherein, based on the first image comprising a knowledge graph based on action information corresponding to an operation of a user and activity information configured with a plurality of pieces of sequential action information:
the obtaining of the user input comprises obtaining a user input for modifying user data related to a first node of the knowledge graph, and
the changing of the text of the journal comprises changing the text of the journal, based on the knowledge graph being modified according to the modified user data.

7. The method of claim 1, further comprising:
displaying, in a second area of the display screen, a second image based on second user data configured to change the text of the journal,
wherein the obtaining of the user input comprises obtaining the user input for modifying the first image using the second image.

8. The method of claim 7, wherein the obtaining of the user input comprises obtaining a user input moving, to the first area, a second image element from among image elements constituting the second image, and
wherein the changing of the text of the journal comprises changing the text of the journal, based on the first image being modified according to moving of the second image element.

9. The method of claim 7, wherein, based on the first image comprising a knowledge graph based on action information corresponding to an operation of a user and activity information configured with a plurality of pieces of sequential action information, and the second image comprising an image element corresponding to action information or activity information based on the second user data:
the obtaining of the user input comprises:
displaying an edge between a second image element and at least one node of the knowledge graph, based on a user input moving, to the first area, the second image element from among image elements constituting the second image, the edge being based on a co-relationship between the second image element and nodes of the knowledge graph of the first image; and
obtaining a user input moving the second image element into the first area such that the second image element is a node of the knowledge graph, and
the changing of the text of the journal comprises changing the text of the journal, based on the knowledge graph being modified according to moving of the second image element.

10. A non-transitory computer-readable recording medium storing instructions that, when executed by at least one processor, cause a device to execute the method of claim 1.

11. A user device comprising:
memory comprising one or more storage media storing instructions;
at least one processor comprising processing circuitry; and
an input/output device configured to output a display screen,
wherein the instructions, when executed by the at least one processor, cause the user device to:
generate a journal using a personal knowledge graph based on user data having a co-relationship,
display a first image and a text of the journal in a first area of the display screen, the first image being generated based on first user data used to generate the journal,
obtain a user input for modifying the first image displayed in the first area, and
change the text of the journal based on the first image being modified.

12. The user device of claim 11, wherein the instructions, when executed by the at least one processor, cause the user device to modify the first image by changing at least one of a type, a position, a state, or a number of image elements constituting the first image.

13. The user device of claim 11, wherein the instructions, when executed by the at least one processor, cause the user device to obtain the user input by obtaining a user input selecting a first image element from among image elements constituting the first image, and change the text of the journal such that a text corresponding to the first image element is identifiable from the text of the journal.

14. The user device of claim 11, wherein the instructions, when executed by the at least one processor, cause the user device to obtain the user input by obtaining a user input deleting a first image element from among image elements constituting the first image, and change the text of the journal such that a text corresponding to the first image element is deleted from the text of the journal.

15. The user device of claim 11, wherein, based on the first image comprising a knowledge graph based on action information corresponding to an operation of a user and activity information configured with a plurality of pieces of sequential action information, the instructions, when executed by the at least one processor, cause the user device to obtain the user input by obtaining a user input moving, in the first area, a position of a first node of the knowledge graph, and change the text of the journal based on the knowledge graph being modified according to a moved position of the first node.

16. The user device of claim 11, wherein, based on the first image comprising a knowledge graph based on action information corresponding to an operation of a user and activity information configured with a plurality of pieces of sequential action information,
the instructions, when executed by the at least one processor, cause the user device to obtain the user input by obtaining a user input for modifying user data related to a first node of the knowledge graph, and change the text of the journal based on the knowledge graph being modified according to the modified user data.

17. The user device of claim 11, wherein the instructions, when executed by the at least one processor, further cause the user device to display, in a second area of the display screen, a second image based on second user data configured to change the text of the journal, and obtain the user input for modifying the first image using the second image.

18. The user device of claim 17, wherein the instructions, when executed by the at least one processor, cause the user device to obtain the user input by obtaining a user input moving, to the first area, a second image element from among image elements constituting the second image, and change the text of the journal based on the first image being modified according to moving of the second image element.

19. The user device of claim 17, wherein, based on the first image comprising a knowledge graph based on action information corresponding to an operation of a user and activity information configured with a plurality of pieces of sequential action information, and the second image comprising an image element corresponding to action information or activity information based on the second user data, the instructions, when executed by the at least one processor, further cause the user device to:
display an edge between a second image element and at least one node of the knowledge graph, in response to a user input moving, to the first area, the second image element from among image elements constituting the second image, the edge being based on a co-relationship between the second image element and nodes of the knowledge graph of the first image,
obtain the user input by obtaining a user input moving the second image element into the first area such that the second image element is a node of the knowledge graph, and
change the text of the journal based on the knowledge graph being modified according to moving of the second image element.

20. The user device of claim 17, wherein the instructions, when executed by the at least one processor, further cause the user device to display, in the second area of the display screen, a plurality of tone mode buttons for changing a tone of the text of the journal, and
wherein the instructions, when executed by the at least one processor, further cause the user device to obtain the user input by obtaining a user input selecting a first tone mode button, and change the text of the journal based on a tone corresponding to the selected first tone mode button.
